(19) United States
(12) Patent Application Publication
(10) Pub. No.: US 2014/0207527 A1
(43) Pub. Date: Jul. 24, 2014

(54) METHOD FOR CORRELATING BUSINESS STRATEGIES FOR GROWTH AND PROFITABILITY WITH ACQUISITION AND USE OF PROPERTY

(71) Applicant: PROXYMITY, LLC, Des Moines, IA (US)

(72) Inventors: John Garvey, Des Moines, IA (US); Kevin Schlueter, Des Moines, IA (US)

(73) Assignee: PROXYMITY, LLC, Des Moines, IA (US)

(21) Appl. No.: 13/745,275

(22) Filed: Jan. 18, 2013

(51) Int. Cl. G06Q 10/06; G06Q 50/16

(52) U.S. Cl. CPC G06Q 10/06375; G06Q 50/16
USPC 705/7.37

(57) ABSTRACT

A strategizing method for ensuring that the matrix that support and address a business's strategies for growth and profitability are highly correlated with the business's property, the features of the property and the uses of the property is disclosed. The selected property, the set of potential uses of the selected property and the one or more features of the selected property are recommended independent of any interest of the recommended party and the selected property or features thereby ensuring an unbiased correlation factor. The method and process address every aspect of a property project and greatly simplify the business's ability to focus on their day-to-day work.

### BACKGROUND OF THE INVENTION

Traditional accounting and business practices view property, such as real estate, owned and used by a business as an expense or just another business transaction. Under this scheme, little or no emphasis is placed on aligning or ensuring a high correlation between the metrics that drive a business's growth and profitability and the property occupied by the business, the features of the property and its uses and function. There remains under this scheme a significant underutilization of a property strategy that supports and enables realization of the metrics that drive business growth and profitability. Furthermore, self-interested advice and counsel manifest in existing schemes is all too often given to a business as to its commitment to, acquisition and use of property; the self-interested advice and counsel conflicts with the independent review necessary to realize a high correlation between the metrics that drive a business's growth and profitability and the property occupied by the business, the features of the property and its uses and function.

### SUMMARY OF THE INVENTION

Therefore, what is needed is a strategizing method for ensuring that the metrics that support and address a business's strategies for growth and profitability are highly correlated with the business's property, the features of the property and the uses and function of the property by recommending a selected property, a set of potential uses and functions of the selected property and one or more features of the selected property independent of any interest of the recommending party in the selected property or features.

According to one embodiment of invention, a method for correlating a business's currently and future strategies for growth and profitability with its commitment to and use of physical property is disclosed. The method includes performing a study of a business to identify a set of factors driving the business's strategy for growth and profitability. A study of one or more properties such as an analysis of a set of potential uses and functions of the property and one or more features of property is also conducted. Based upon the use analysis a selection is made. The selection includes selecting a property from one or more properties wherein the set of potential uses and functions of the selected property have a high correlation factor with the set of factors driving the business's strategy for growth and profitability. The selection step may also include selecting a set of features selected from one or more features of the property wherein the set of potential uses and functions of the one or more features of the selected property have a high correlation factor with the set of factors driving the business's strategy for growth and profitability. Beneficially, this method coverts the expense of committing to and acquiring the selected property with its one or more features into an investment providing a return to the business based on the high correlation factor between the set of potential uses and functions of the selected property and the set of factors driving the business's strategy for growth and profitability and the set of potential uses and functions of the one or more features of the selected property and the set of factors driving the business's strategy for growth and profitability. Advantageously, the selected property and the set of potential uses and functions of the selected property and the one or more features of the selected property are recommended independent of any interest of the recommended party in the selected property or features.

### BRIEF DESCRIPTION OF THE DRAWINGS

The appended figures illustrate certain features or aspects related to examples of the invention. The figures include:

FIG. 1 is a flow diagram illustrating an overview of a method of the present invention.

FIG. 2 is another illustration of a property method according to an embodiment of the present invention.

FIG. 3 is an illustration comparing one method of appraisal for a property with an optimized appraisal method according to one aspect of the present invention.

FIG. 4 is an illustration of a set of investment categories driving a business culture considered as factored in the method of the present invention.

FIG. 5 is an illustration showing various considerations a business strategizes over when assembling a property discovery team.

FIG. 6 is an exemplary workbook for identifying property discovery team members responsible for business strategies as shown in FIG. 5.

FIG. 7 is an illustration of communication strategies for engaging and driving discussions with the property discovery team according to one aspect of the invention.

FIG. 8A is an overview illustration of an exemplary balanced property strategy process.

FIG. 8B is an illustration of an overview for an aspect of the property discovery process according to one exemplary aspect of the present invention.

FIG. 9 is an illustration of an overview for understanding a business's needs by determining the status of a business.

FIG. 10 is an exemplary workbook for determining the current status of a business as illustrated in FIG. 9.

FIG. 11 is an illustration of an overview understanding of a business's external trends by determining a set of primary influences acting on the business.

FIG. 12 is an exemplary workbook for determining the external trends of a business as illustrated in FIG. 11.

FIG. 13 is an illustration of an overview understanding of a set of factors that influence a business's external trends according to one aspect of the invention.

FIG. 14 is an exemplary workbook for determining societal impact on a business's external trends as shown in FIG. 13.

FIG. 15 is an exemplary workbook for determining community impact on a business's external trends as shown in FIG. 13.

FIG. 16 is an exemplary workbook for determining industry impact on a business's external trends as shown in FIG. 13.

FIG. 17 is exemplary workbook for determining economy impact on a business's external trends as shown in FIG. 13.

FIG. 18 is an exemplary content summary of a property risks and opportunities (PROP) report according to an aspect of the present invention.

FIG. 19 is an exemplary PROP report for company vision as listed in FIG. 18.

FIG. 20 is an exemplary PROP report for company objectives as listed in FIG. 18.

FIG. 21 is an exemplary PROP report for company key influences as listed in FIG. 18.

FIG. 22 is an exemplary PROP report for company risk and opportunities as listed in FIG. 18.

FIG. 23 is an exemplary PROP report for a physical criteria analysis as listed in FIG. 18.

FIG. 24 is an exemplary PROP report for a financial criteria analysis as listed in FIG. 18.

FIG. 25 is an exemplary PROP report for business statistics for the company as listed in FIG. 18.

FIG. 26 is an exemplary PROP report for business statistics for the company as listed in FIG. 18.

FIG. 27 is an exemplary PROP report for recommending steps for the company to take as listed in FIG. 18.

FIG. 28 is a diagram of a computer system that might be used with the method of the present invention.

### DETAILED DESCRIPTION OF THE PREFERRED EMBODIMENTS

For a better understanding of the invention, several examples of forms the invention can take will be described in detail. Reference will be taken from time to time to the figures listed above in the Brief Description of the Drawings.

It is to be understood that the primary example will be discussed in the context of a strategizing method for ensuring that the metrics that support and address a business's strategies for growth and profitability are highly correlated with the business's property, the features of the property and the uses and function of the property. However, variations obvious to those skilled in the art will be included in the invention, which is not necessarily limited to the precise primary exemplary embodiment. The invention can be applied in analogous ways to other property strategies.

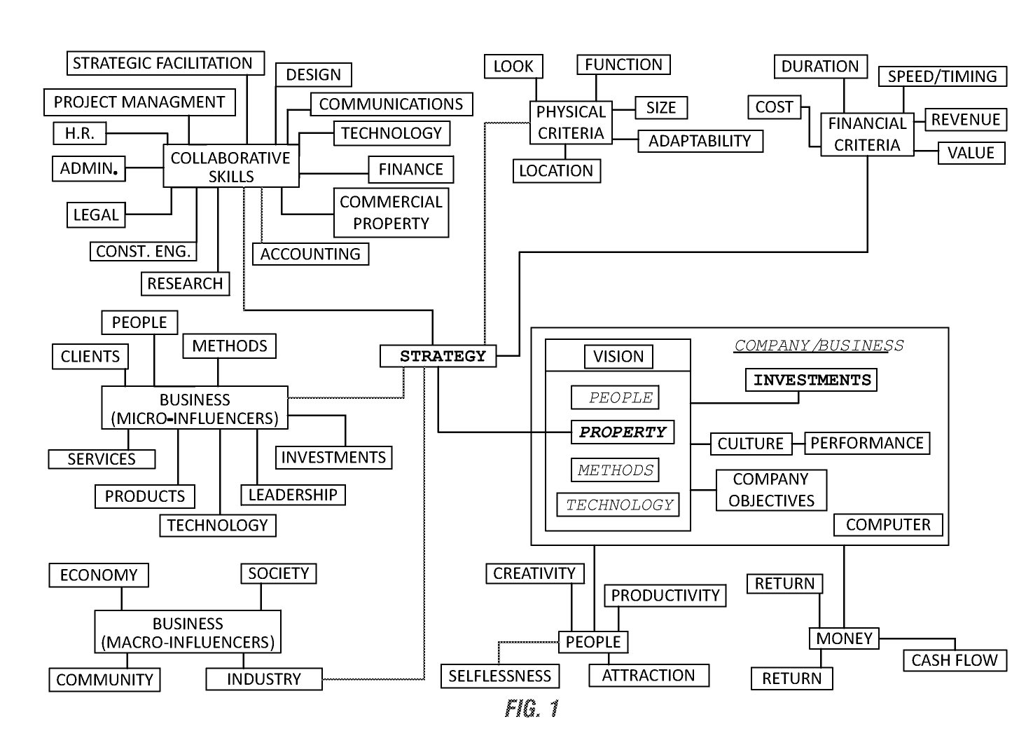

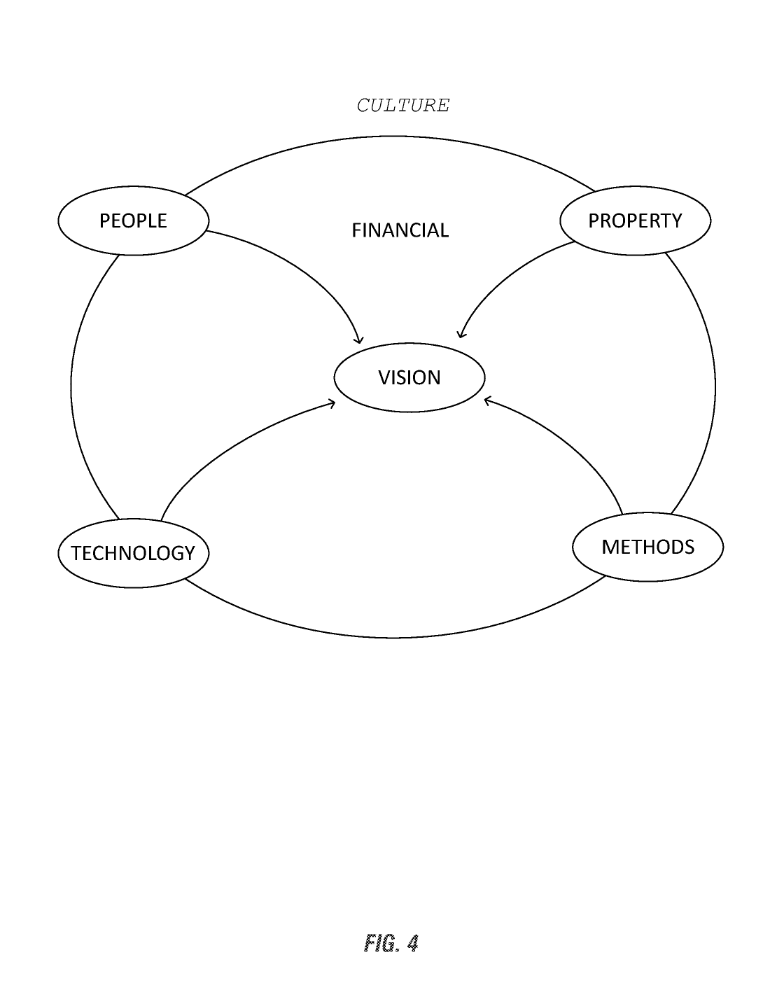

FIG. 1 provides an overview of an exemplary method of the present invention for ensuring that the matrix that support and address a business's strategies for growth and profitability are high correlated with the business's property, the features of the property and the uses and functions of the property before the business commits to or acquires the property. At the core of this method is the company or business looking to align their property strategies with their business strategies for growth and profitability. To better understand how a business or company looks at and uses property requires a thorough analysis of a company or business's culture. As diagrammed in FIG. 4 at the center of a business or company is the company's vision. Key aspects are calculated into and contribute significantly to a company's vision and are part of the daily operation of the business. The categories that make up a business are its people, the methods and technology the business uses and the business's property. Each one of these categories drive a company's vision based on the emphasis placed on each, (e.g., resources of the company allocated to each category). Each of these categories represents a certain cost to the business to operate. As a result, a business generally continues to develop their people through training, hiring, education, etc. A business will also look at ways to improve their methods and their systems to increase efficiencies for conducting their business. Businesses continually invest almost always heavily in technology as it is always changing and providing more efficient ways for conducting business. However, of these categories, the same analysis, continual development improvement of and its relationship to a company's overall strategy is often overlooked when it relates to the business's property. For example, companies look at their property much different than how they look at developing and improving their people, technology methods and system. When property is considered as part of this strategy, it no longer is a transaction that occurs, for example, every five to ten years for a business, but when considered as a strategic component of having a balanced business helps create the necessary culture within a business for the business to be successful. Leaving property strategies out of the equation illustrated in FIG. 4 creates an imbalance in a business that impairs the business's culture and its ultimate performance. Each of these components is handled differently, is invested in differently, and is viewed differently by each company. However, each of these components has a highly integrated responsibility to a company's culture and ultimate performance. For example, a company's objectives influences how each of these categories are regarded, handled, invested in, etc. Notwithstanding property being a key cog in the ultimate performance of a business, it is often given little consideration as to how it could be strategized to drive the culture and ultimate performance of a business. Recognizing that a business's property is not just another expense or business transaction leads the business to often recognize significant under utilizations of the property in a manner and strategy that supports and enables realization of metrics that drive the business's growth and profitability.

FIG. 1 provides an overview of a number of matrix that are considered to help a business understand how their property can be used as a key strategy component for driving culture and the ultimate performance of the business. Each of these factors or metrics are analyzed and described in detail below. The intent with FIG. 1 is to provide an overview summary of the various factors considered to develop a strategy for a business's property. There are several inputs into the development of a strategy for property. In fact, the creation of a property strategy looks at, according to one exemplary aspect of the present invention, the change and the rate of change a business will experience and the rate of change occurring in the business's surrounding, environment or setting. Categories that influence these factors directly affect why and how a business uses its property over a specified period of time. There are micro-influencers that determine a business's property strategy and specifically how the business will need to use the property to meet the business's strategies for growth and profitability. The term micro-influencers is used to indicate factors that influence the business internally as opposed to macro-influencers which relates to factors that influence the business externally or external influences on the business. Some micro-influencers from within the business that affect the use of property and should be calculated into a company's property strategy include, for example, the company's people, their methods of business, financial investments, leadership, technology, services/produces, and their clients. These factors all heavily influence how a business uses property to meet its business strategies for growth and profitability. Outside of the business, the world in which the business operates, there are other influencers or factors that affect the way the business will strategize over and ultimately use property. The change or the rate of change of each of these influencers must be understood in order to determine how each of them will impact the company's property strategy. For example, the economy, a society, a community and the specific industry within which the business operates all have an effect on why the company uses certain property for certain functions and how the company will use that property, not just today but into the future over an understood period of time. To understand how each of these influencers will impact a company's property strategy, an independent assessment of each must be made. The independent assessment uses collaborative skills that a business uses in some way, when thinking about, committing to, strategizing, or transacting any sort of property solution. In fact, the provide an independent solution, such collaborative skills as project management, strategic facilitation, finance, communications, research, commercial property, design, construction/engineering, technology, legal, human resource, accounting, and administration are all part of developing an independent team or assessment panel to help a business understand how to think about, commit to, strategize, or transact any sort of property solution that might drive the business's strategies for growth and profitability. The assessments conducted using these types of collaborative skills provide a property strategy team or assessment panel with information how to prioritize and model a company's investments in property, both physically and financially. The physical priorities identified in the property study include such considerations as function of the property, size of the property, adaptability of the property, location of the property and look of the property. The financial factors include such factors as duration of use, cost, and value of the property, revenue from the property and speed and timing for implementation of the property strategy. This cumulative information, assembled and analyzed, creates a comprehensive plan that identifies the knowledge, decision and actions a business should take relating to a property strategy to drive growth and profitability of a company. Given consideration to all of these factors for developing a property strategy provides a business with a unique and dynamic plan that is relevant both in the present and in the future for growth and profitability. When the physical criteria become solutions created wholly in support of a company's vision, the cash allocations of a company to property are no longer an expense but an investment with a specific, identifiable return. That return, ultimately, is the success of the company's vision and the resulting performance of the company, its growth and profitability. With a property strategy developed as an investment with an identifiable return, a purposeful culture tied to a company's vision results which affect the performance of the company (i.e., its people) and the company's money.

A company that has a culture tied to its vision and a property strategy that supports the company objectives resulting in a high success or performance also affects the performance of the business's people. For example, the business becomes more attractive to potential hires, investors, business partners, etc. The productivity and creativity of the people in the business also increases and the people become more willing to sacrifice for and put the business's interests first as they are able to identify and realize returns on their investment (e.g., sacrifices) into the business. Having the pillars that support a company's vision (e.g., people, property, methods, technology) in balance and a property strategy in place for use of the property resulting in a purposeful culture tied to the vision of the company also affects the performance of the company's money. For example, the business experiences higher rates of investment, return and increased cash flow.

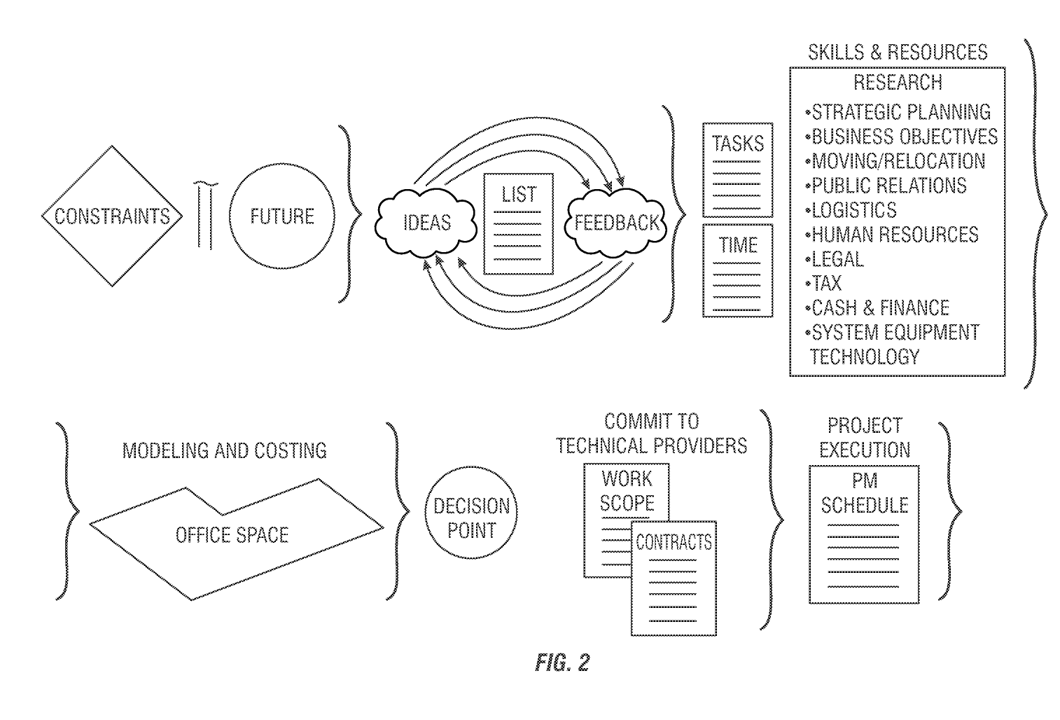

FIG. 2 provides an illustration of a strategizing method for insuring that the metrics that support and address a business' strategy for growth and profitability are highly correlated with the business' property, the features of the property and uses of function of the property, thereby using property as a means for accomplishing future goals. As a business identifies constraints and obstacles inhibiting future growth and profitability, ideas and feedback are provided for accomplishing future goals for growth and profitability by overcoming current constraints. A collaborative process occurs where ideas and feedback are exchanged to identify the timing of the task and the skills and resources that will be needed to accomplish the task in the projected timing. Once the skills and resources are identified to accomplish the task in the projected timing, the collaborated process moves to identify the modeling and costing variables for the particular business or company. These steps are all undertaking before any commitment by the business or company to begin project execution. Once the foregoing parameters have been finalized and a decision has been made the company or business commits to the technical providers and the project begins execution of aligning the company or business' strategies for growth and profitability with the business' property, the features of the property and the uses and functions of the property.

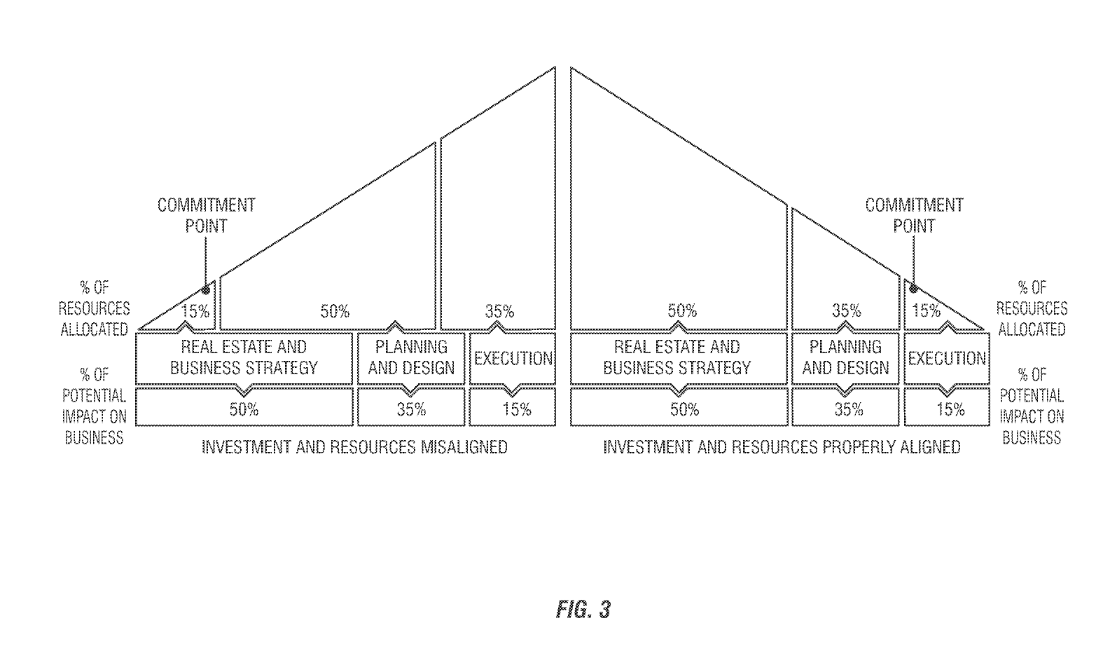

Because real estate is typically the largest fixed asset for a business and its second largest expense it is often viewed as a millstone, a necessary evil, rather than a key to greater profitability and growth through enhanced productivity, contained expenses, and promoting an overarching plan for the future as shown in FIG. 2. By way of example, a business may spend more than 500 hours on a typical real estate project. The significant amount of hours require business owners and key officers time which is taken away from their primary duties which results in reduced profitability and potential for growth. Businesses and companies often commit to a contract prematurely hoping that the project will work out. This is often done at the detriment of the buyer or tenants own strategic vision, and ultimate failure of pre-aligning the companies' business strategies for growth and profitability with the property, the features of the property and uses and functions of the property. The traditional commercial real estate transaction often works against the company or business. For example, by committing to a project early on, a business may wave much of their leverage, leaving them responsible for future, unforeseen expenses. Methods and aspects of the present invention focus on the commitment point which affords the opportunity for a business to determine its corporate vision and ensure its property will align with its long-term goals. As shown in FIG. 3, deferring the time of commitment also allows the business to become knowledgeable about the process to make informed decisions, compared to forced learning and increased expense at each crises point. Through purposeful commitment, a business maintains control of its directives, not requests. Problems which develop during the process aren't the company's responsibility which keeps a hard line on the expenses and timeline. As illustrated, in a transaction using an unoptimized approached or the traditional method, early commitment to a real estate project leaves little time and few resources to spend on strategic thinking. Once a business or company is committed, planning, design and execution take considerably more time and money than necessary as they are retroactively shaped to accommodate developing strategy. Conversely, the present invention provides a strategic approach for strategizing property by aligning efforts with potential business impact driving company growth and profitability. For example, by committing at the right points of the process, more time can be spent in developing a real estate solution well before major cost begin accumulating. The property strategy or property then can develop naturally, and on budget, as an extension of the property strategy. When the time to commit arrives, execution is a function of planning, not reacting to each new development.

According to one method of the present invention, a team is identified for the company or business that has the necessary skills for guiding the process as will be discussed later. Steps included in this process are generally labeled as discovery phase parameters. The purpose of the formation of a team within the company or business is to bring together the knowledge and expertise that will allow the business to identify what drives its profits and growth so that business metrics may be aligned with the property occupied by the business or the features of property and its uses and functions.

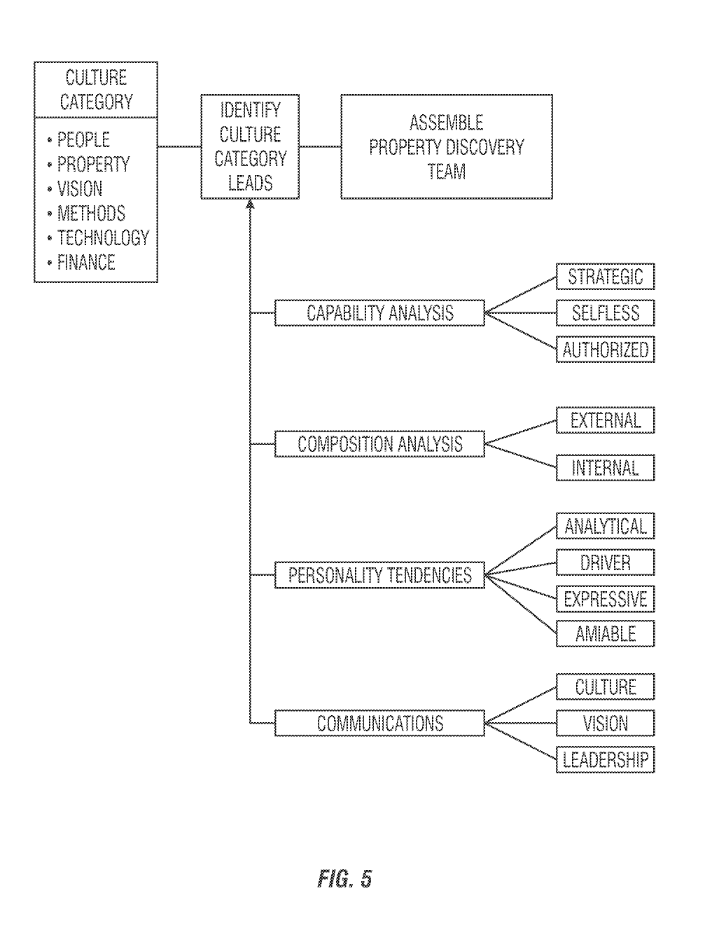

Communication with the company or business through the discovery stage is of great importance. According to one exemplary aspect of the discovery phase, certain parameters are identified to provide a property strategy. Certain parameters are necessary when considering the members of the team, understanding that the culture of a business or organization is driven by the combination of those categories listed in the culture category shown in FIG. 5, namely the company's people, their property, their vision, their methods, their technology, and their finance. Each of these categories has a lead or person in charge that brings valuable experience to the team. Each of the team members for the individual categories worked collaboratively to create a clear path to developing and strategizing a method for insuring that the metrics that support and address a business' strategies for growth and profitability are highly correlated with the business property, the features of the property and the uses and function of the property. As shown in FIG. 4 and in the culture category in FIG. 5, the first category is the vision of the business or organization. In one aspect of the invention, there are four categories in support of the company or business' vision, namely its people, its methods, its technology, and its property. Each of these categories has a need of resources to fulfill its goals to drive growth and profitability. Therefore, each has a financial need or is supported by a financial input. Each of the categories has a different, but highly integrated responsibility to the overall process. These categories form quintessential components of the process.

Each of the culture categories listed in FIG. 5 and shown in FIG. 4 have leaders or visionaries who drive objectives or goals within each of the categories for obtaining maximum growth and profitability for the business or company. The visionaries for each of these categories may come from different departments or areas within the business or company. For example, the CEO or president, the board of directors, founder and/or primary or majority owner(s) often control the energy and vision of the future to come for each business or organization. Each visionary for the above categories is largely responsible to articulate the vision, motivate the leaders and integrate the leaders for each category and build consensus on plans going forward to drive maximum growth and profitability for the company or business. Within this context it is understood that the people of the business or company form the core of the organization. Even in highly automated businesses the people are the creative energy that dictates the success of any vision. The leaders of each of the individual categories then identify the characteristics, values and standards that should be embodied by the people within the business or organizations. By an inventory of a business' people, for example, understanding the demographics such as the type of people by division and/or category, their education, development and learning traits and needs, compensations structures and their alternatives or benefits provides insight into an inventory analysis.

A business' methods are important as to how the business operates and thereby drives growth and profitability. The methods of a business are directed by the mission and values of the organization and evidenced in the business' processes and standards. One of the greatest evidences of a business' methods is in its products and services. Understanding a businesses' products, services, programs, productions and project management, organizational structure, research and development, marketing and public relationships, sales tactics, accounting and control structures, risk management, and legal protections, contractual requirements, business partnerships and key relationships provides insights into a business' operations or its methods. Understanding the core technologies that drive profit and growth of a business is also key in understanding the business or organization. For example, technology can advance quickly. The purpose of technology is to make an organization's people more efficient (quick) or more affective (improve quality). The leader of the technology organization should understand emerging technologies, enterprise systems, business analysis (e.g., alignment of systems to organization and its people), and, perhaps paramount, communication systems. A leader of the financial categories is responsible to strategize plans for the division of the company or organization through collaboration. Strategies require capital resources (e.g., time, energy and money) that must be assessed and balanced to provide the greatest impact and return on investment. Leads in the financial category are interested in understanding, for example, characteristics such as rates of investment, return on investment, value, capital flow, cash flow, financial structures (e.g. capital, cash, task, etc.), and emerging practices and opportunities. The property category also requires a lead that has skills to strategize dysfunction, adaptability, location/community, look and size, etc. Property considerations include research, project management, acquisition, leasing, architecture, interior design, space and functionality planning, comfort and safety systems, construction, process engineering, furnishing and equipment systems, contract, and risk management considerations to fully appreciate how property can provide a company or organization opportunities for growth and profitability.

There are several considerations that help a company or organization identify culture category leaders or leads as illustrated in FIG. 5. These leaders are identified to take lead of each of the culture categories listed, for example, in FIGS. 4 and 5. A capability analysis may need to be performed to identify a leader who is strategically capable, selfless and authorized. The trait of being strategic is important as this allows the leader to objectively lead to support a common vision when gathering information, producing ideas and creating plans. The leader should also exhibit a selfless trait and be devoted exclusively to the good of the organization and its vision. Being authorized allows the leader of category to clear requests and expectations of commitment and contribution to the plan. The composition of leaders of each category may also be comprised of people, for example, internal (within the company) or externally (consultant or otherwise), one or more people or persons may fill more than one category lead position. Personality and tendencies is also a studied undertaking to identify category leaders.

Generally speaking, the most powerful strategy comes from a team comprised of leaders for each category having at least some of the primary personality traits or personality tendencies as illustrated in FIG. 5. It is important, for example, to assemble a team of leaders for each of the categories with as many of the listed characteristics. For example, a team of four expressive individuals will likely not possess the skills of an analytical member. A comprehensive team of leaders for each category will be able to create a properties solution that promotes the entire organizations wellbeing. Some of the key attributes for personality tendencies include the ability to think analytically, provide and promote perspective and understand risk management considerations. For example, an analytical thinker is aware of wrongs and is able to identify solutions to the problems. A drive is also an important characteristic to have in team leaders for each of the categories; a driver provides vision and energy. Expressive characteristics are also key for each of the leaders of the organization in providing wisdom or knowledge rightly applied, for example, as to operational understandings of the business or organization. Being amiable is also a key characteristic for category leaders especially when dealing with the community or communications internally or externally. Amiable characteristics allow the team to identify the things that can be done and the people that can be reached. Analytical and driver personality tendencies have generally a strong orientation in intellect and task, whereas expressive and amiable personality tendencies have a strong orientation in people, in emotional and intelligence. A balance of these four personalities will provide the widest range of perspective and will make each of the leaders of the different categories more efficient in generating and assessing ideas, seeing opportunities and managing risks. Lastly, communications is key to cultural category leaders for each of the cultural categories previously identified. The initial assembly of a team of leaders for each of the categories provides a clear message to the business or organization as to the leaders within the business or organization who define culture, vision and leadership. Understanding how these selections impact the organization or business should also be considered when assembling each of the leaders for the categories. The end result of this assessment and appointment process is the assembling of a property discovery team within the business or organization.

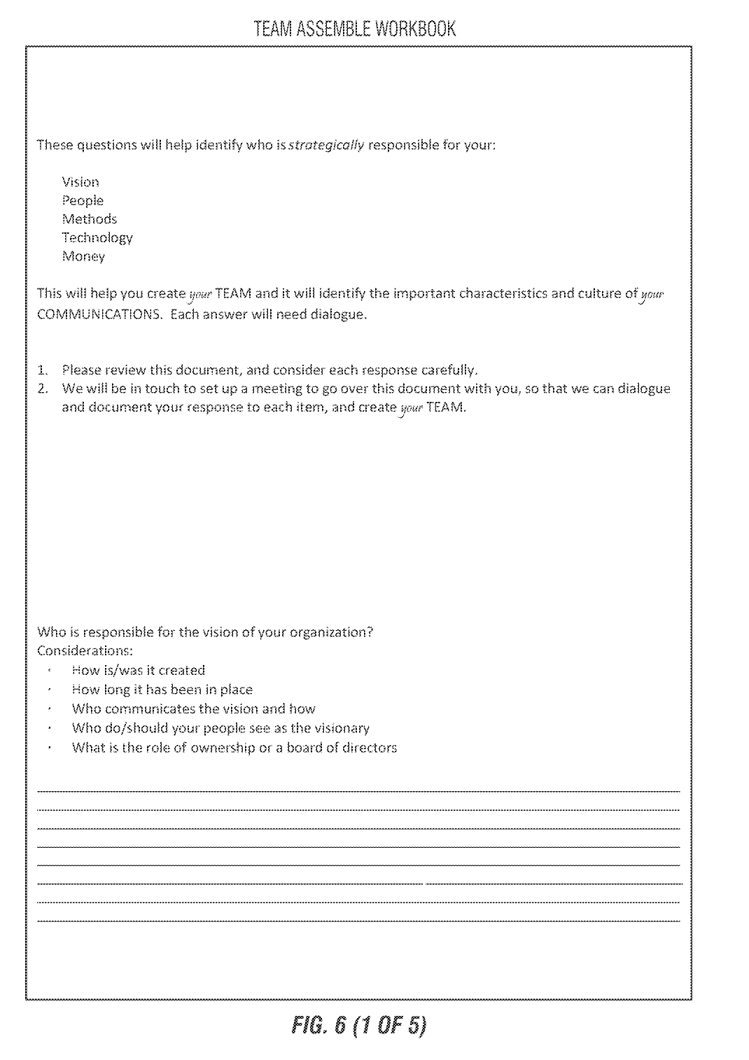

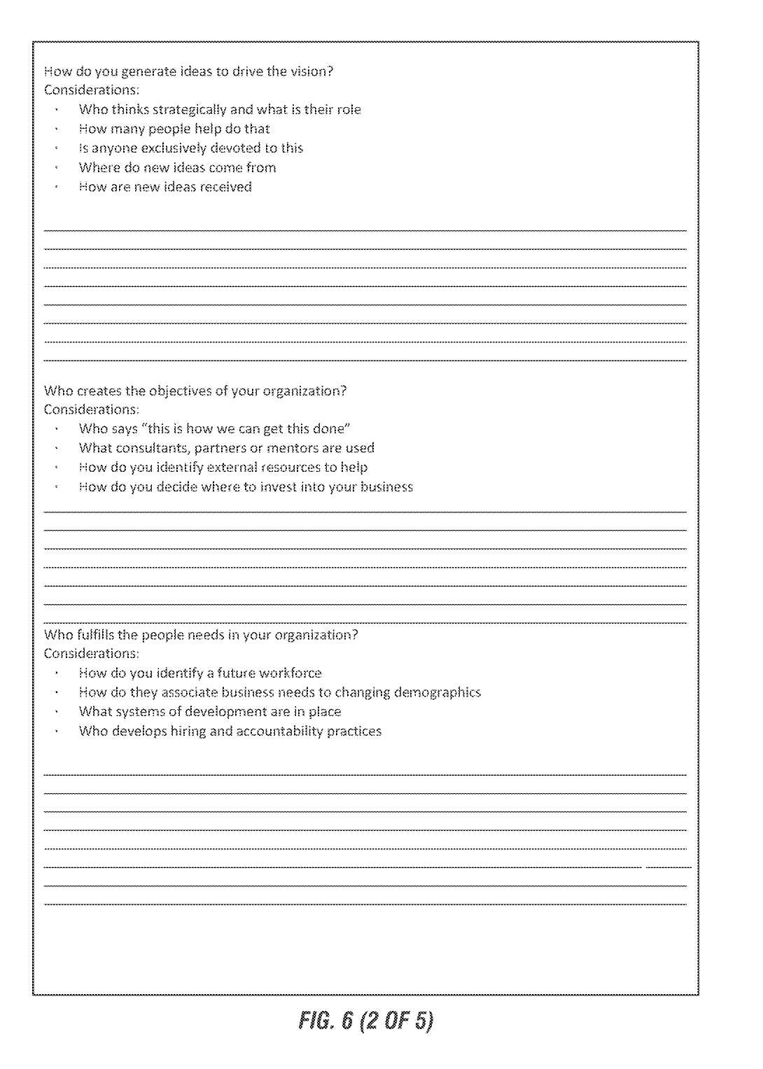

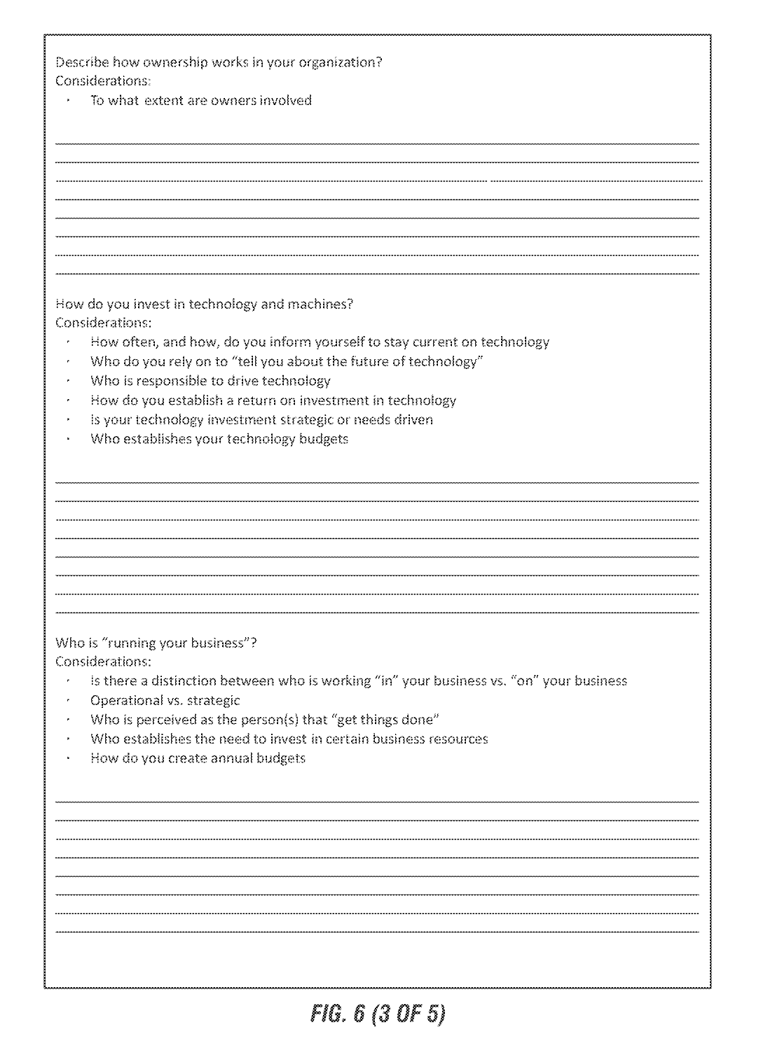

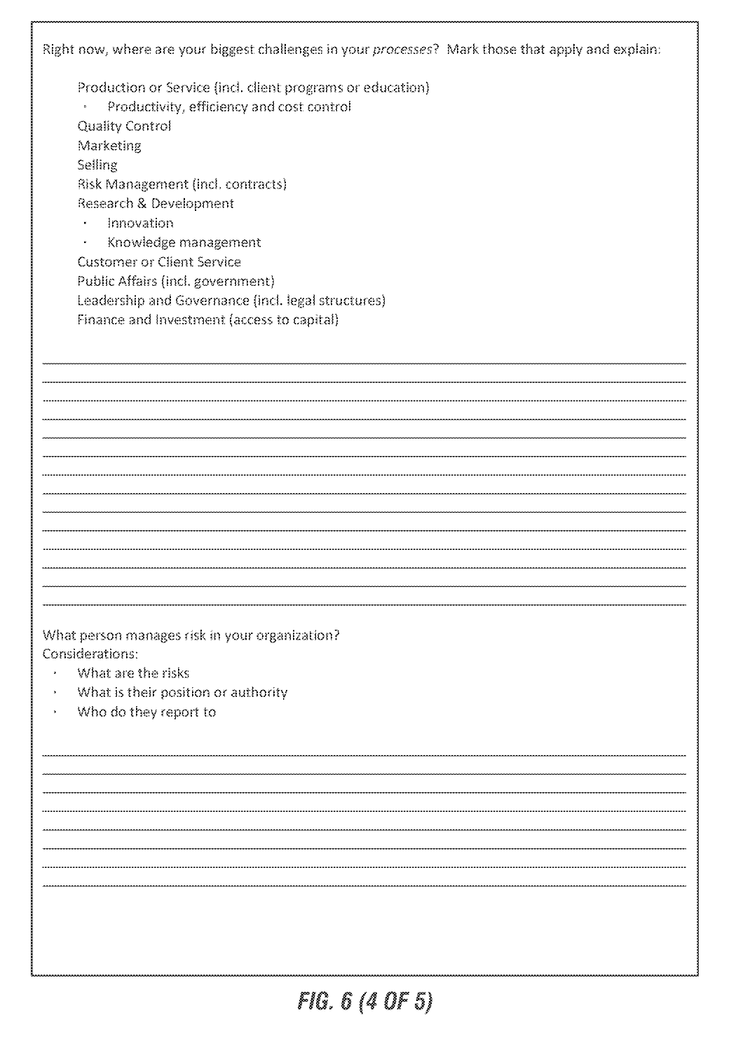

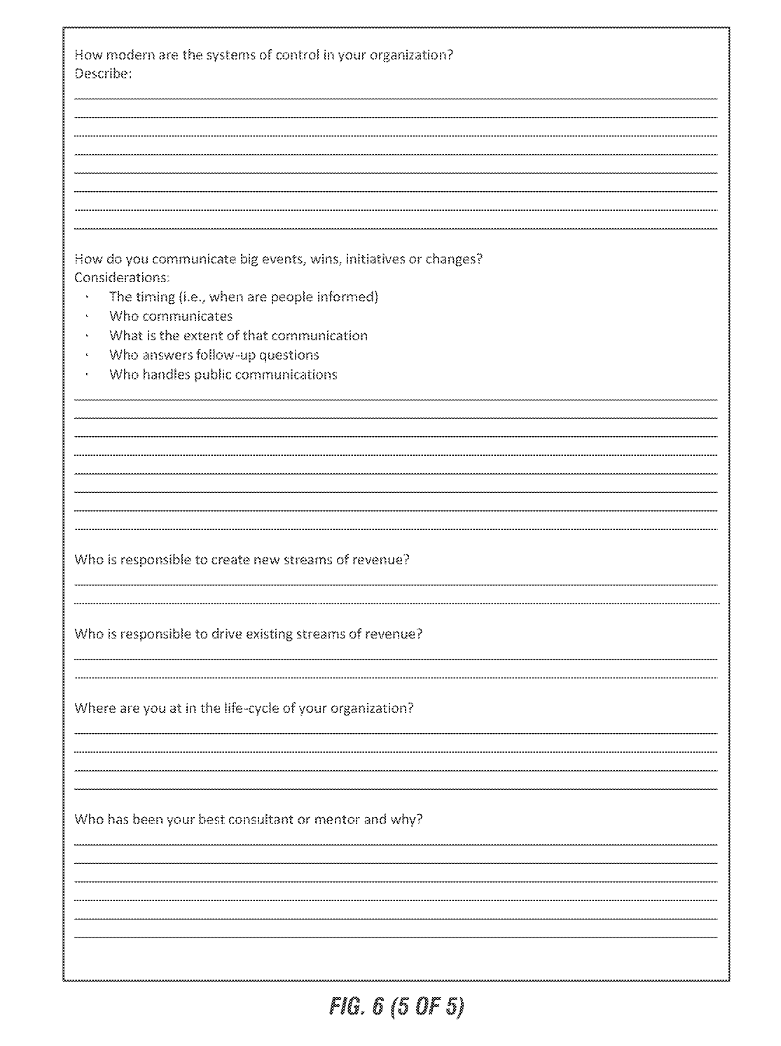

FIG. 6, which includes pages 1 through 5, provides an exemplary questionnaire for assembling the team of leaders for each of the categories previously described. The purpose of the team assembly questionnaire is to help identify who within the company or organization will be responsible for strategically leading the individual categories of vision, people, methods, technology, and finances and money. The team assembly questionnaire provides one example of a workbook or questionnaire for the company or business to use to identify the individuals strategically responsible for each category. The questionnaire is provided as but one example and should not be construed as limiting the present invention. The team assembly questionnaire helps the business or organization to identify important characteristics and culture of the communications for the business or organization. Some considerations include, for example, identifying who is responsible for the vision of the business or organization. Factors to consider may include such things as how the vision is created, how long it has been in place, who communicates the vision and how, who should the people within the business or organization see as the visionary, and/or what the role of ownership and the board of directors would be in the creation of the businesses or organization's vision. Other considerations or factors include how the business or organization generates ideas to drive the vision of the business or organization. Some factors include, for example, who within the business or organization thinks strategically and what is their role, how many people help with this undertaking, and is anyone exclusively devoted to this or where do new ideas come from and how are these ideas received. Understanding the objectives of the organization of business may be further identified by considering who the leaders are within the organization or business. Also, what consultants, partners or mentors are used by the business, how the business identifies external resources for help and how the business identifies where to invest within the business. Also considered within the team assembly questionnaire is the question about the people's needs within the business or organization. Some considerations include, for example, identifying how you identify future a workforce, how do you pay associates, the change in demographics, what systems of development are in place, and/or who develops higher accountability practices. The illustration on page 3-5 of FIG. 6 provides additional criteria to consider for the team assembly workbook, according to an exemplary aspect of the invention. Other queries include describing how ownership works within the business or organization which may include considerations such as to what extent are the owners involved. Also considered is how does the organization or business invest in technology and machines. These include taking into consideration how often and how does the business inform itself or stay current on technology, who does the business rely on to tell them about the future of technology, who is responsible to drive technology, how does the business establish a return on investment and technology, is the business' technology investment strategic or does it need to be driven, and/or who within the business or organization establishes the budget for technology. Also within this context, it's important to understand who is running the business. Considerations to understand who's running the business or organization include identifying a distinction between who is working in the business or who is working on business matters, identifying operational verses strategic considerations, identifying who is perceived as an individual that is capable of getting things done, considering the needs to invest in certain business resources and/or having the capacity or understanding to create annual budgets. Illustration 4 of 5 of FIG. 6 also provides additional queries and criteria to forming a team of category leaders. Understanding a business or organization also requires understanding their business or organizations biggest challenges to their processes. Several criteria help identify challenges within the businesses processes such as, for example, the type of production or services including client programs or education, the productivity, efficiency and cost control of the same, quality control, marketing, selling, risk management (including contracts), research and development (e.g., innovation and knowledge management), customer client service, public affairs (including government), leadership and government (including legal structures), and/or finance investment (e.g. access to capital). Another query important to assembling a team of leaders for each of the aforementioned categories defining the culture of a business include identifying what person or persons manage risk within a business or organization. Factors driving this consideration include what are the risks, what is their position or authority, and/or who do they report to. Illustration 5 of 5 of FIG. 6 also provides additional criteria for identifying information to provide or set up a group of team leaders for each of the aforementioned categories. These queries include, for example, how modern are the systems of control within the business or organization, how does the business or organization communicates big events, wins, initiatives, or changes, who is responsible to create new streams of revenue within the business or organization, who is responsible to drive existing streams of revenue within the business or organization, where's the business at in the life cycle of the organization, and/or who within the businesses is considered the best consultant or mentor. Communication is a key component in driving leadership of the strategic cultural categories. For example, communicating information can be impacted, for example, by the timing (i.e., when are people informed), who communicates the information, what is the extent of the communication, who answers follow up questions to the communication, and/or who handles public communications (e.g. communications to customers, owners, stock holders, investors, etc.).

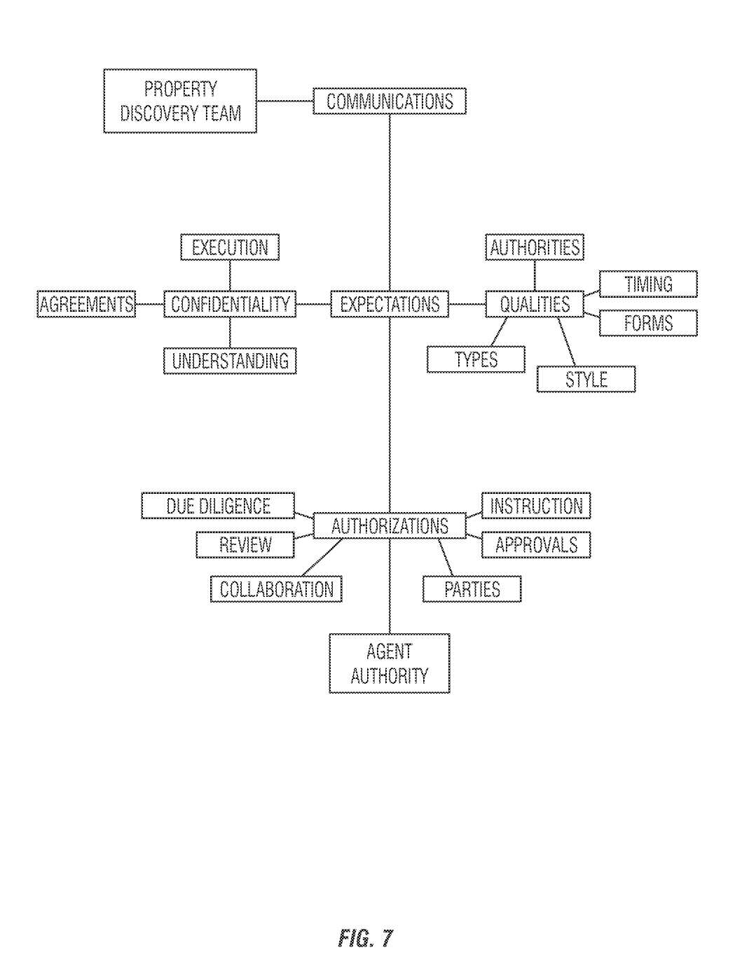

FIG. 7 provides additional illustrations, by way of example, of the importance of communications within the business or organization, communications about the business or organization and/or communications from the business or organization. For example, the assembly of a team that is focused on a common vision of understanding the organization, past, present and future is important to develop a complete property strategy. In order for that to happen, communication must be open, honest, energetic and thoughtful. Considerations as to how the team will communicate include, for example, such expectations as confidentiality and qualities of the correspondence or communications. The confidentiality of communications with the business and from the business are also important to maintain a relationship where both sides feel free to communicate information. Agreements such as mutual confidentiality or non-disclosure agreements may be signed and put in place thereby memorializing the intent to work with the business or organization in a private and confidential manner. The expectation, and the confidentiality being communicated, should apprise the business or organization that there is a commitment to work with them that does not include the furthering of personal interests but is focused on servicing the business or organization, the employees of the business or organization, and furthering the vision of the business or organization. Understanding the confidentiality allows the free flow of information from the business or organization to better understand each of the aforementioned categories of the business to thereby provide a property analysis that addresses the business's strategies for growth and profitability by identifying high correlations with the business's property, the features of the property by recommending, for example, a selected property, a set of potential uses and functions of the selected property and one or more features of the selected property independent of any interest of the recommended party and selected property or features is disclosed. Other considerations giving to communications within the organization or business include an understanding of how the business is to communicate within the organization and how the business or organization communicates information relating to each of the aforementioned categories. Factors to consider include the authorities involved within the communications, the timing of the communications, the types of communications (e.g., in person, email, memo style, meetings, etc.) and/or the styles of communication (e.g., open, close, etc.). Since communications (informal or formal) are an integral part of the existing culture within a business or organization and how the business or organization sees its future, it is important to understand this so as to know how to communicate when working with the business or organization. Understanding the organizational chart of the business and the key business alliances partners and/or consultants is key in understanding how to communicate with the business, leaders of each of the cultural categories for setting forth and defining the role that is to be played in helping develop a property strategy. Included in communications is the importance of obtaining proper authorizations. This includes, for example, establishing a person that is to be directly responsible for matters. This may include authorizations from the leader that has made the decision to be engaged, and/or the individual who is holding others accountable for the work to be performed on behalf of the organization. For example, authorizations may need to be acquired to receive instruction or direction as to how to engage others within the business or organization throughout the work process. Other authorizations may be required to review important communications, such as requests for information reports before they are sent to others. Also, authorizations may need to be acquired for communicating any information outside of the company. From these authorizations, all of the communication responsibilities will team authorities will guide the dos and the don'ts of working with each of the team leaders and teams for the cultural categories, employees of the business or organization, business partners or other consultants, and/or ownership groups.

After the business or organization has assembled their team of leaders for each of the cultural categories and identified the types of communication and communication guidelines, the next step or stage in the process is the discovery phase work. The purpose of the discovery phase work is to uncover information that will aid in creating knowledge and feedback for the business or organization. The knowledge will provide the business or organization with key information for operating profitably and driving future growth by means of their property, which will be included in the property report provided to the business or organization. The work being performed is outlined and provided to the business or organization in sections of the document, for example, provided by way of illustration in the figures. These may include, for example, an overview of the discovery stage which summarizes the importance of each of the steps for the business or organization, the work steps that would be involved which explain the work and who is responsible for each part of the work, and an understanding of the current status of the business or organization which explains requests for information, which may include informational checklists, an understanding of the business's external trends which may include research provided to the business with feedback to allow the production of strategic knowledge to be applied to the organization or business, and/or understanding the future of the business which may include an explanation of the tools that could be used to gain a full appreciation of the vision, culture and objectives of the business or organization. The result of this work is a complete property risk and opportunities (PROP) report. For example, the report may be configured to show the relationship of property to the business's culture and how it contributes to the performance of the business or organization. The report may also be configured to show how a comprehensive strategy is created including the timing and cost of implementing both.

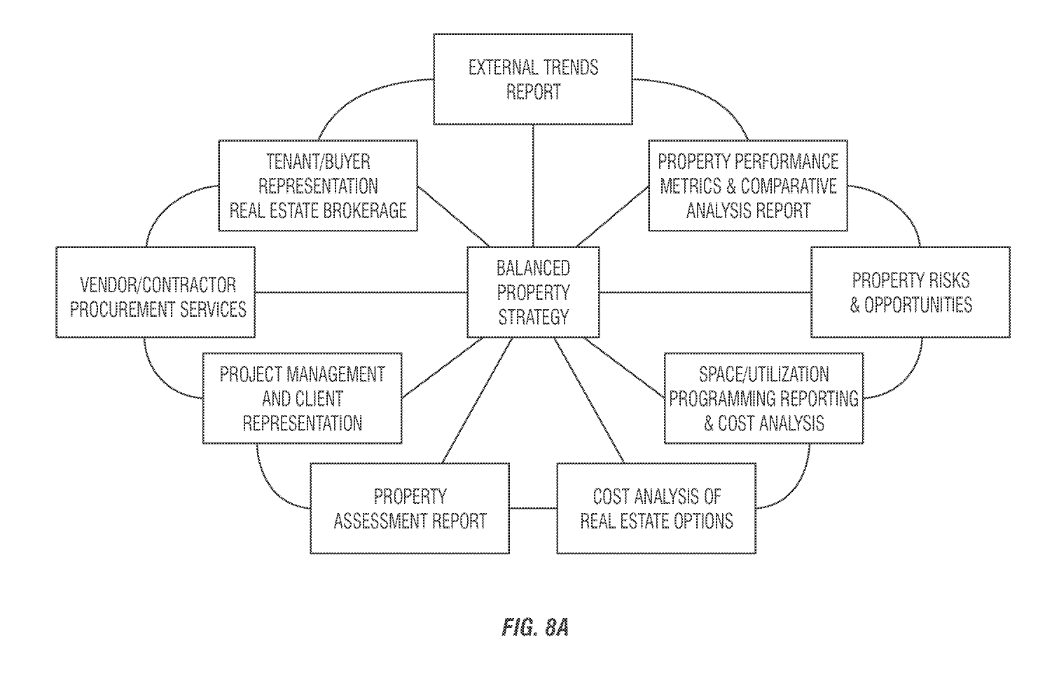

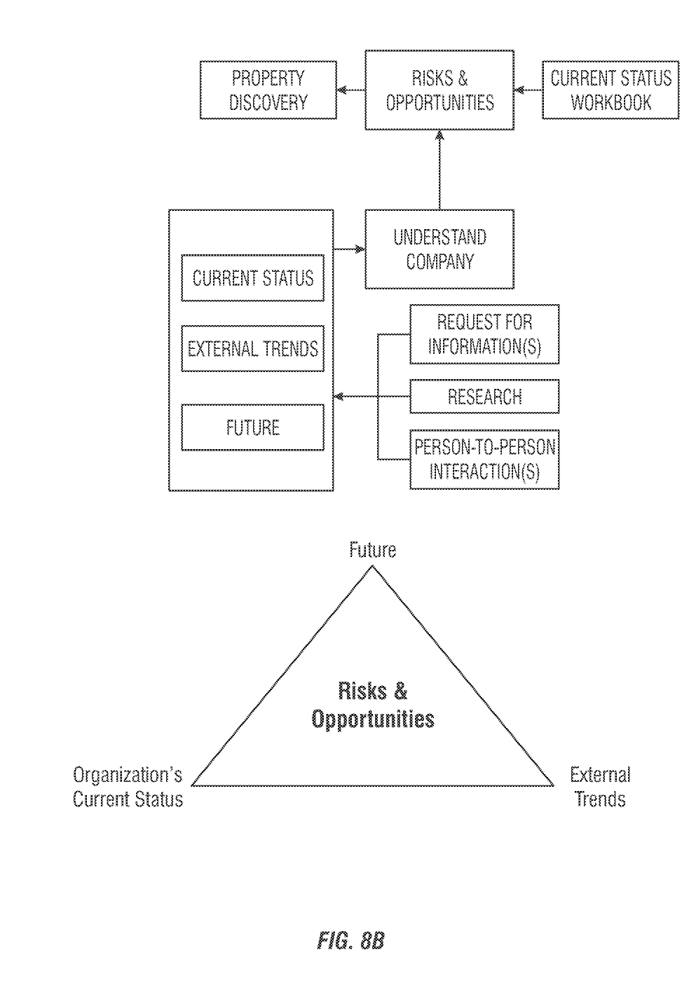

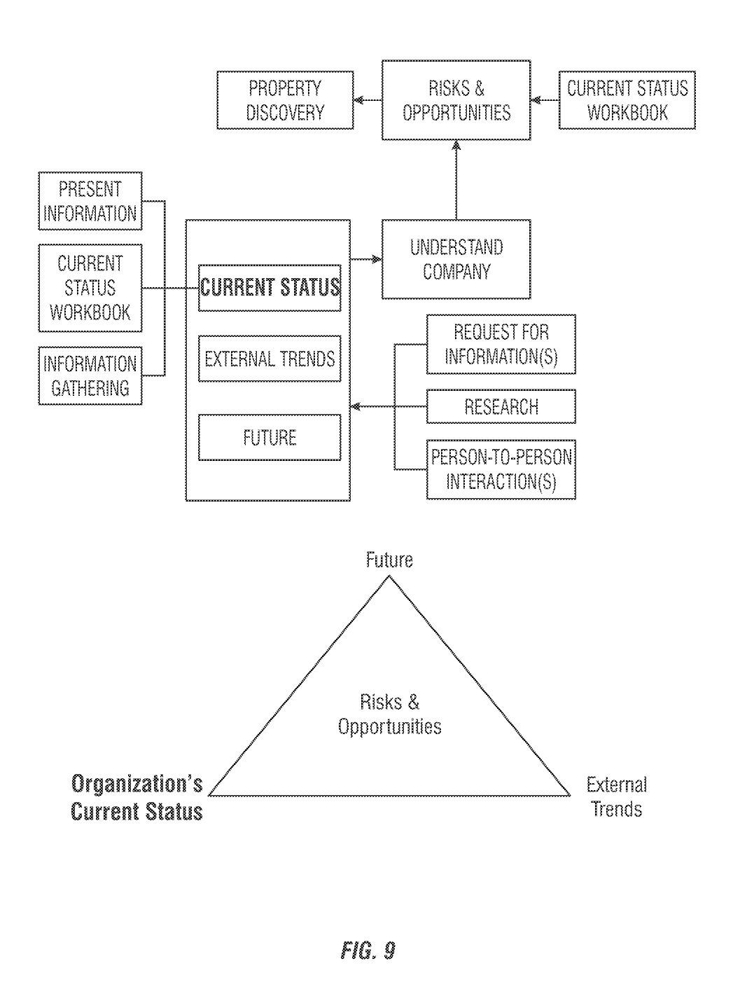

FIG. 8A is a diagram illustrating a balanced property strategy according to an exemplary process of the present invention. As shown, the balanced property strategy may include, for example, providing a company or organization with an external trends report. the external trends report may be compiled to include topics for the business or organization to consider for key areas, such as for example, community, industry, society, and economy. These four areas are generally identified as having the greatest impact on a business or organization while at the same time are largely uncontrollable by the business or organization. The external trends report may also be configured with the current realities and the projected impact of these forces on the client or organization. Also part of the balanced property strategy is a property performance metrics and comparative analysis report. This report breaks down measurable real estate and productivity metrics (e.g., both capital and operational) and provides detailed financial data to measure throughout the process and the life of the property. These metrics, for example, are customized for the specific business or organization. Also considered with the balanced property strategy is the property risks and opportunities. The property risks and opportunities (PROP) report is an executive tool, for example, to show how property can be used to support and drive the business or organization's objectives and vision. The report analyzes, for example, the property's contribution to the future of the business or organization by understanding the convergence of three influences. The business or organization's objectives and changes in the business or organization's people, technologies, methods and financial investment, as viewed through the commercial property, are critically analyzed and compiled to expose how property can be used to drive the performance of people, money and ultimately the culture of a business or organization. This report generally drives its analysis through the five physical and five financial criteria that any commercial property user must consider. The result is easily understood strategic information and alternatives that management and executives of the business or organization use as a plan for the future. The report may include, for example, key metrics, financial ratios, comparative analysis and qualitative dialog. Another consideration for a balanced property strategy of the present invention includes an analysis of space/utilization, programming, reporting and cost. This analysis determines the optimum size and functionality of the interior of the commercial space, within a set of defined parameters and assumptions. In addition to the analysis for physical criteria, cost, and constructability, alternative analyses may also be provided to the business or organization. The balanced property strategy also considers a cost analysis of real estate options. Using technical and collaborative real estate expertise, complete cost and schedule budgets of each identified property are provided with respect to each specifically identified piece of real estate. A property assessment report may also be included as part of the balanced property strategy process. The achievement of business objectives through property is the purpose of this report. A detailed road map for the physical and financial real estate criteria is provided to be used in the execution of the business or organization's real estate transaction. Also included, for example, are the results of all phases prior—combined with real life opportunities in the market. Also considered in the balanced property strategy, for example, is a project management and client representation analysis. Since all aspects of the project are managed, all project work, initiatives and providers/vendors are coordinated throughout the process. The system of the present invention helps ensure that all work is completed with a strict focus on the business or organization's project goals. Communications to the business or organization ensure an awareness of progress, alternatives, changes and key decisions to be made. The balanced property strategy or methodology ensures that the business or organization's decisions are made with a full understanding of the cost and impact, given the best alternatives. The report or analysis provides costs, schedule, quality, alternatives and value through the commercial real estate process. Other aspects considered in a balanced property strategy include the vendor/contractor procurement services. Knowing how to procure, manage risk and bring value out of every phase of real estate is an important part of the process of the present invention. These include, for example, having knowledge of the scope, cost and schedule of the process. Using experience to assist the business or organization in structuring the contracts and purchases that benefit them is also important. The reports associated with the balanced property strategy align the greatest value in the industry with the business or organization's unique needs. Since the process of soliciting, interviewing, recommending and negotiating contracts for all project vendors, contractors and service providers is provided, payment made for any work performed may be reconciled and confirmed so as to be correct and accurate. This may include, for example, a log or maintaining a log or complete project documentation report. A tenant/buyer representation real estate brokerage analysis may also be included with the balanced property strategy methodology. For example, full service brokerage services could be provided to the client or organization to include the identification of property parameters, an initial real estate market analysis, the refinement of location requirements, review of potential properties and future developments. The work that may result is a comparative analysis of select properties. The work may be completed through the negotiation and lease or acquisition commitment to process according to an exemplary aspect of the invention. The aforementioned process can be packaged and provided to the business or organization as a whole thereby including all reports, analysis and processes of the method. Other considerations including allowing the business or organization the flexibility to select, for example a la carte, the individual reports, analysis and processes of the method according to their specific need(s). The method and process provide the ability for every aspect of a property project to be addressed, and greatly simplifies the organization or business's ability so that they can focus on their day-to-day work

FIG. 8B provides an exemplary illustration for one stage of the discovery phase according to an aspect of the present invention. Discovery work has two primary objectives, namely to understand the business or organization and to provide feedback about the roles that property plays in the business or organization's vision and culture. Ultimately, according to one aspect of the invention, all of this work is captured in a single document such as a PROP report. To understand the business or organization better, several tools are used such as requests for information, research, and/or end person dialog, meeting or facilitation (e.g., person-to-person interactions). Other tools are contemplated, however, these three tools according to one aspect of the invention are adequate in developing the strategy to create information to understand the business or organization's current status (e.g., who the business currently is), the business's external trends (e.g., what the rest of the world is doing and how it can affect a business), and the business's future (e.g., where the organization is being driven). The combination of all three of these characteristics exposes the business's risks and opportunities. All three of these are combined in an informational report, such as a PROP report. The diagram illustrated in FIG. 8B provides an illustration for these three characteristics of the business and how they provide an insight into the risks and opportunities for the business in developing a PROP report that addresses the business strategies for growth and profitability relating to the business's property, the features of the property and the uses and function of the property by recommending a selected property, a set of potential uses and functions of the selected property and one or more features of the selected property independent of any interest of the recommended party and the selected property or features. The PROP report is intended to be independent and objective and an efficient way to share information with the business or organization where property is working for them or where it may be working against the. The PROP report also is intended, at least in one example of the present invention, to show the business what work needs to be done (e.g., scope, timing, cost) to formulate a comprehensive strategy. This work may provide a clear picture of where the business needs to focus, their resources in creating an ideal property solution. Identifying a business or organization's risks and opportunities is key to the assessment for developing a PROP report and strategy. Included in the risk and opportunity report is a current status workbook which may include, for example, a checklist for the business or organization identifying information to be gathered and provided and questions to be addressed and provided information to as well. A research analysis is performed to determine what affects the business or organization has now and in the future. According to one aspect of the invention, the focus of this analysis includes an understanding of the organization according to each of the following topics, namely, the community within which the organization or business operates, the industry within which the business or organization operates, the society within which the business or organization operates and/or the economy which the business or organization operates. Information is then provided to the business or organization in the form of a workbook according to at least one aspect of the invention.

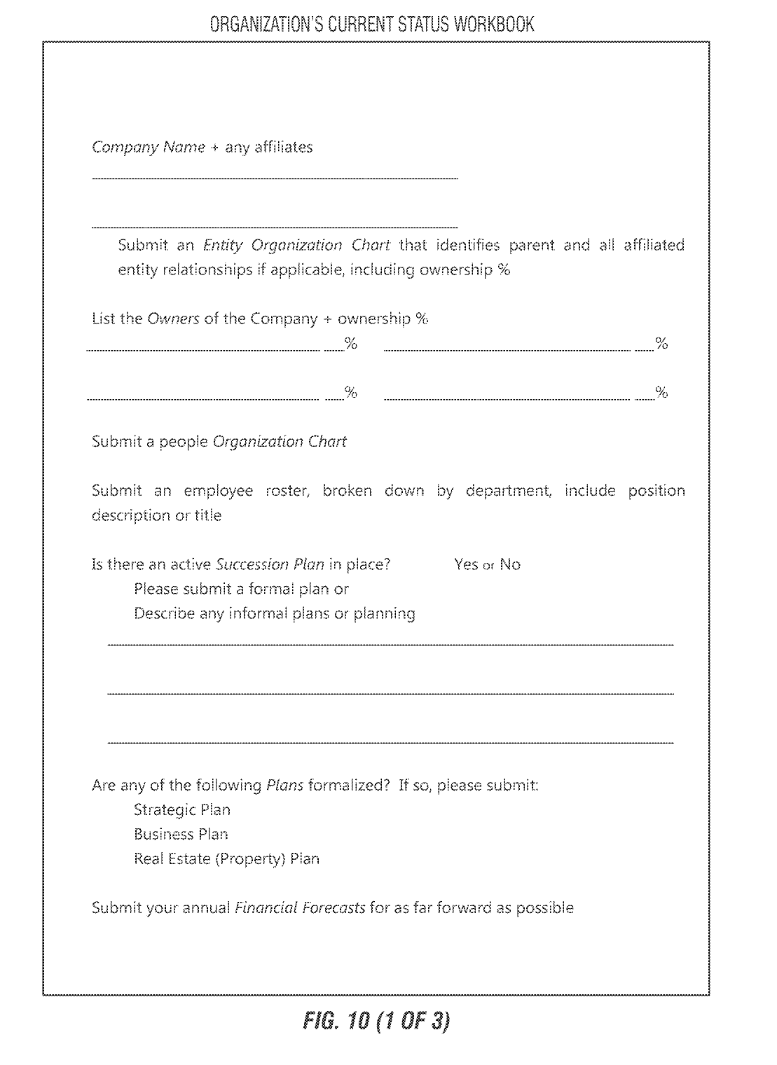

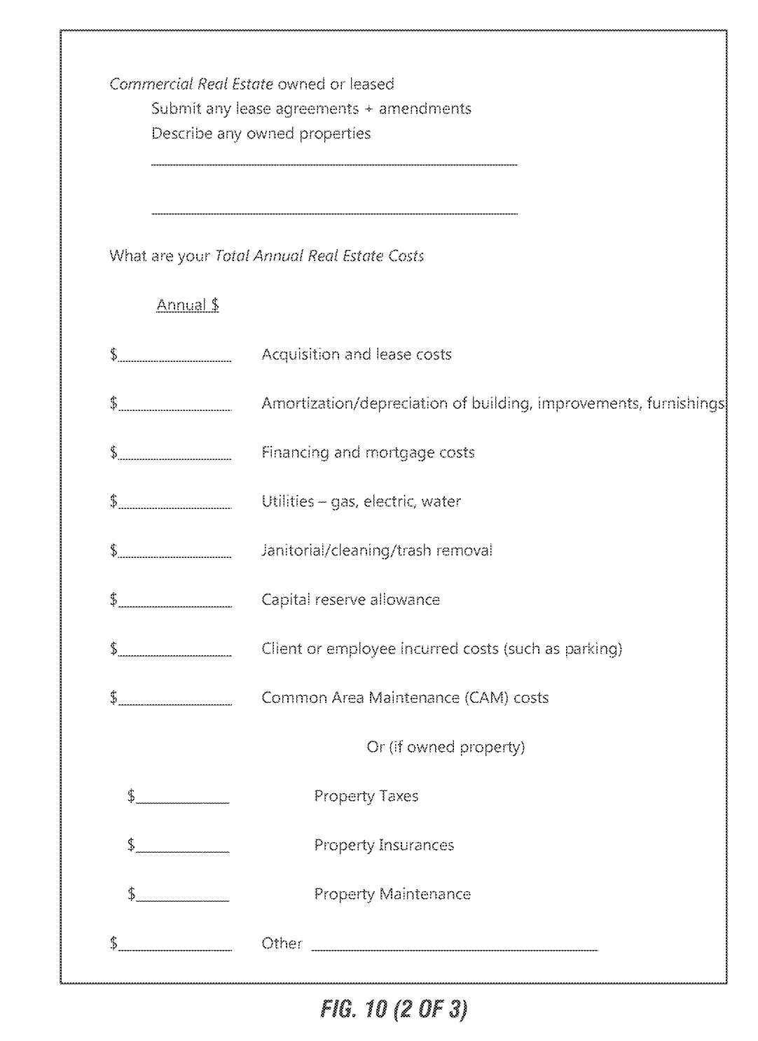

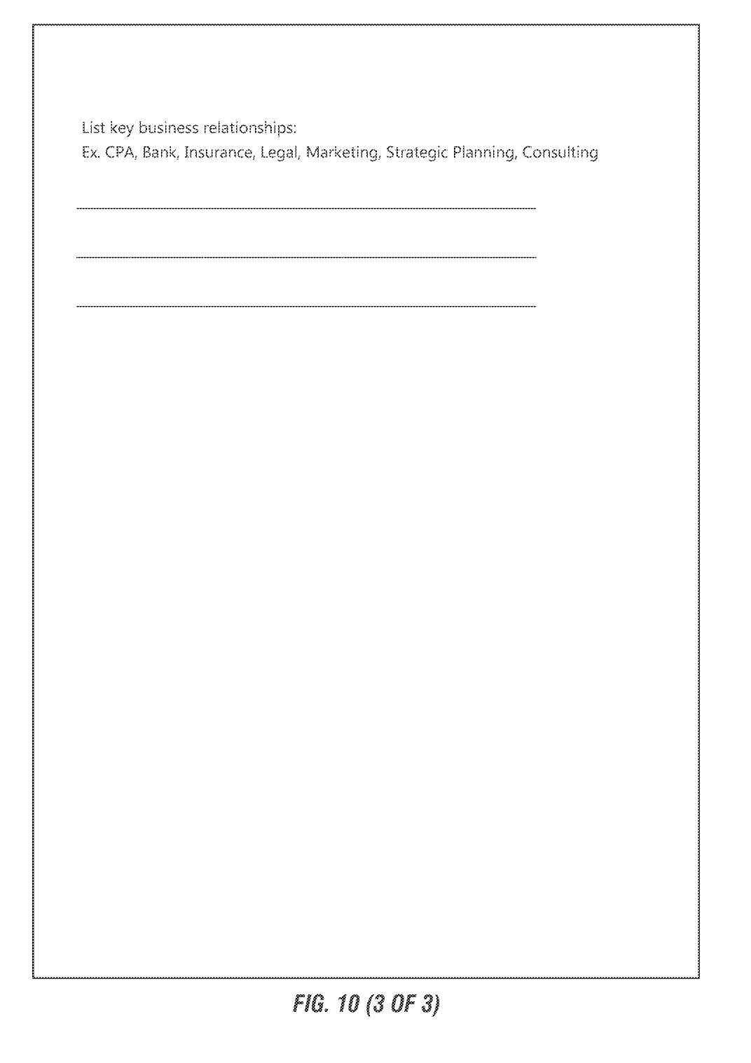

Another important aspect for providing a PROP report includes obtaining an understanding of the business or organization's current status. This includes presenting and gathering information from the business or organization using, for example, a current status workbook illustrated in pages 1-3 of FIG. 10. The current status workbook provides and verifies an understanding of the business or organization so that the risk and opportunities can be better defined when compared to the business or organization external trends and their future. The more that is known about the business or organization the more targeted PROP report can be provided that provides tactical solutions which will result in cost savings and enhanced quality. Providing the complete analysis of the business's current status requires, for example, reviewing the current status workbook provided in FIG. 10, gathering information by the business and returning information to, for example, project manager's for each of the cultural categories. Some factors, provided by way of example only, listed in the current status workbook include the company name and any affiliates associated with the company which may include submission of an organizational chart that identifies parent and all affiliated entity relationships, if applicable, including ownership percentage of each. Other information includes organization charts for the people within the company, employee rosters, for example, broken down by department that include position descriptions or titles. Other information include whether or not the business has an active succession plan in place or whether a strategic, business or real estate property plan has been previously formalized or is in the process of being formalized. Annual financial forecasts for the future looking as far ahead as possible are also important queries to consider when addressing the characteristics for the current status workbook. On page 2 of 3 of FIG. 10, additional criteria is also provided such as whether the business owns any commercial real estate or leases any commercial real estate and if so, whether there are agreements or amendments to agreements that could be provided to gain a better understanding of these arrangements. A total annual real estate cost breakdown is also a key consideration as well as any key business relationships with, for example, a certified public accountant, bank or insurance business, legal entity, marketing group, a strategic planning organization or consulting firm. These, and/or other parameters or characteristics, help develop the organization's current status workbook, thereby providing a better understanding of the current status of the organization relative to its current operations and methods, including other cultural variables.

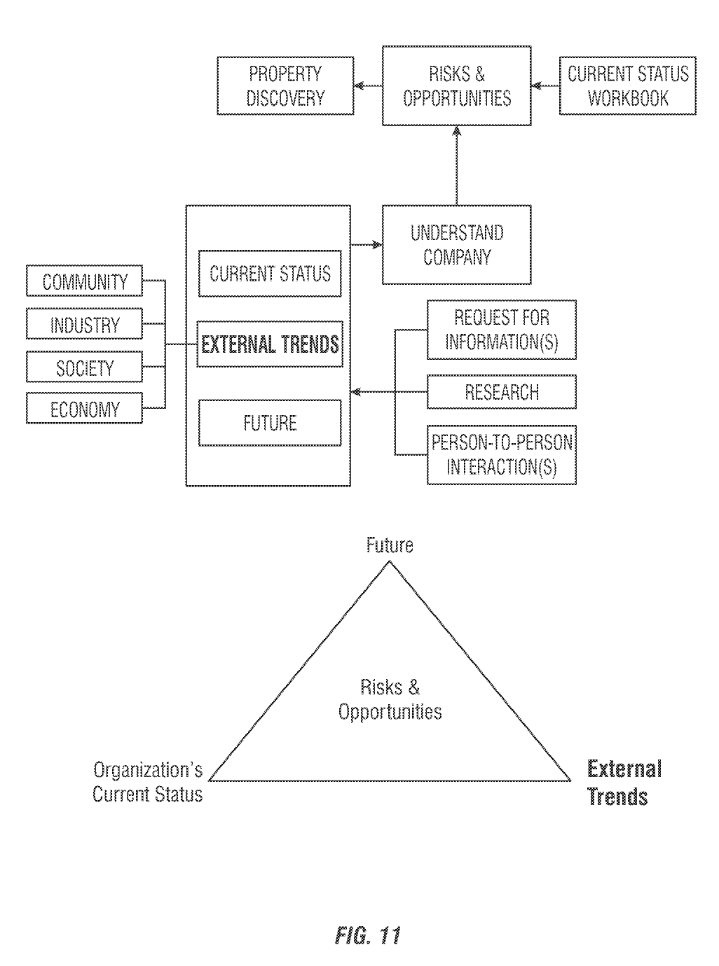

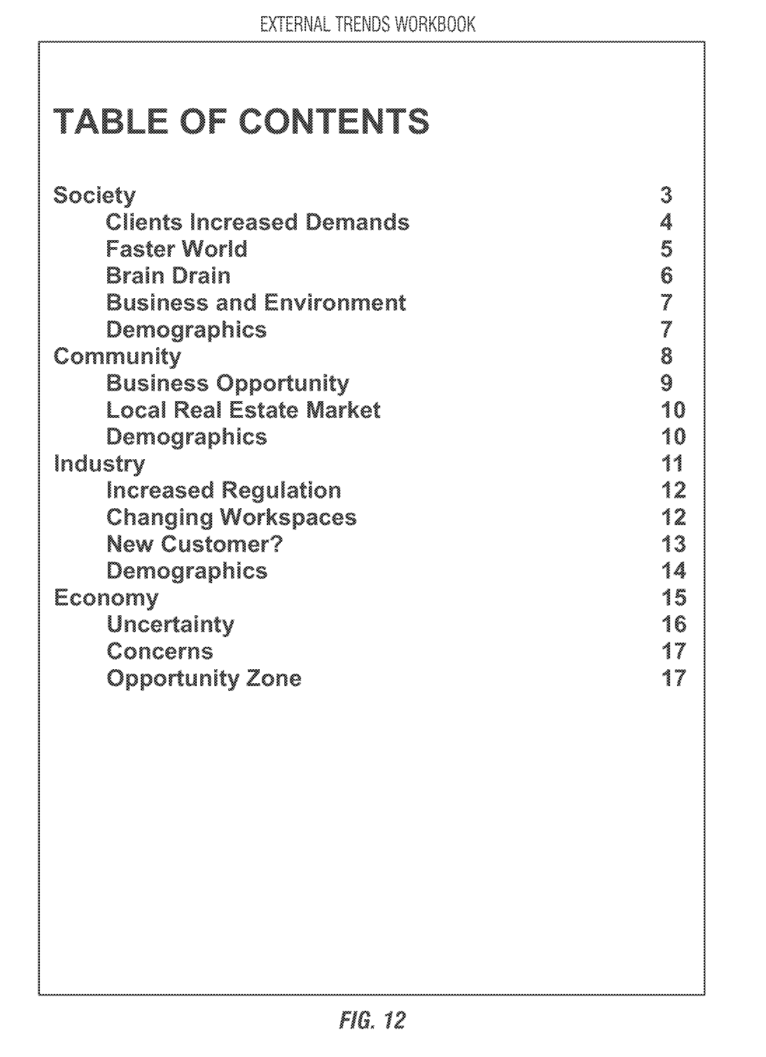

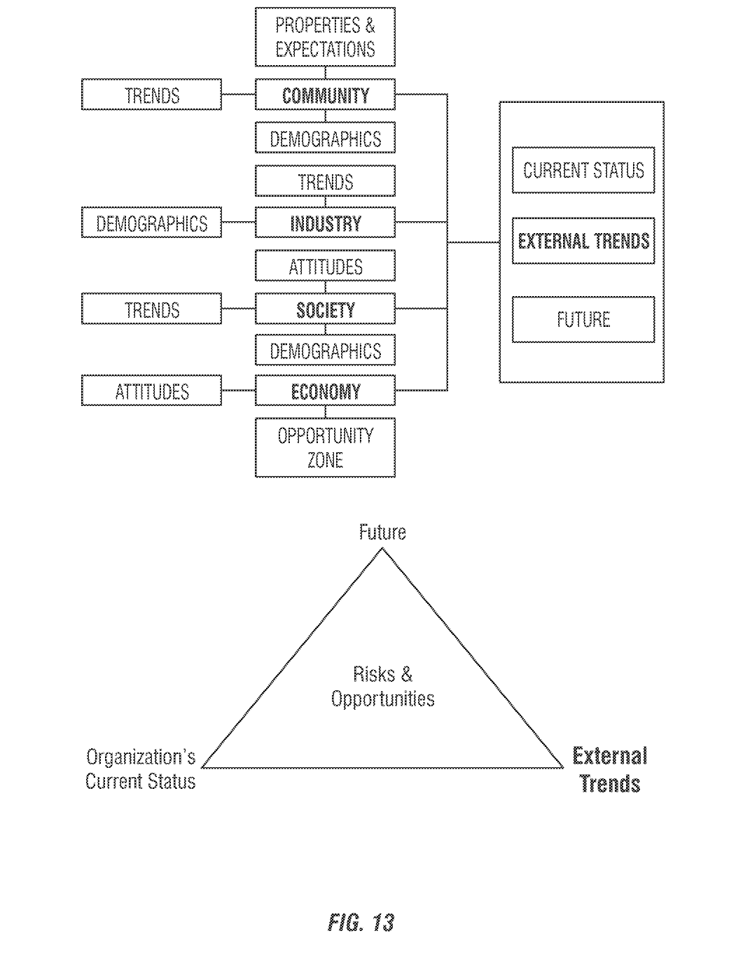

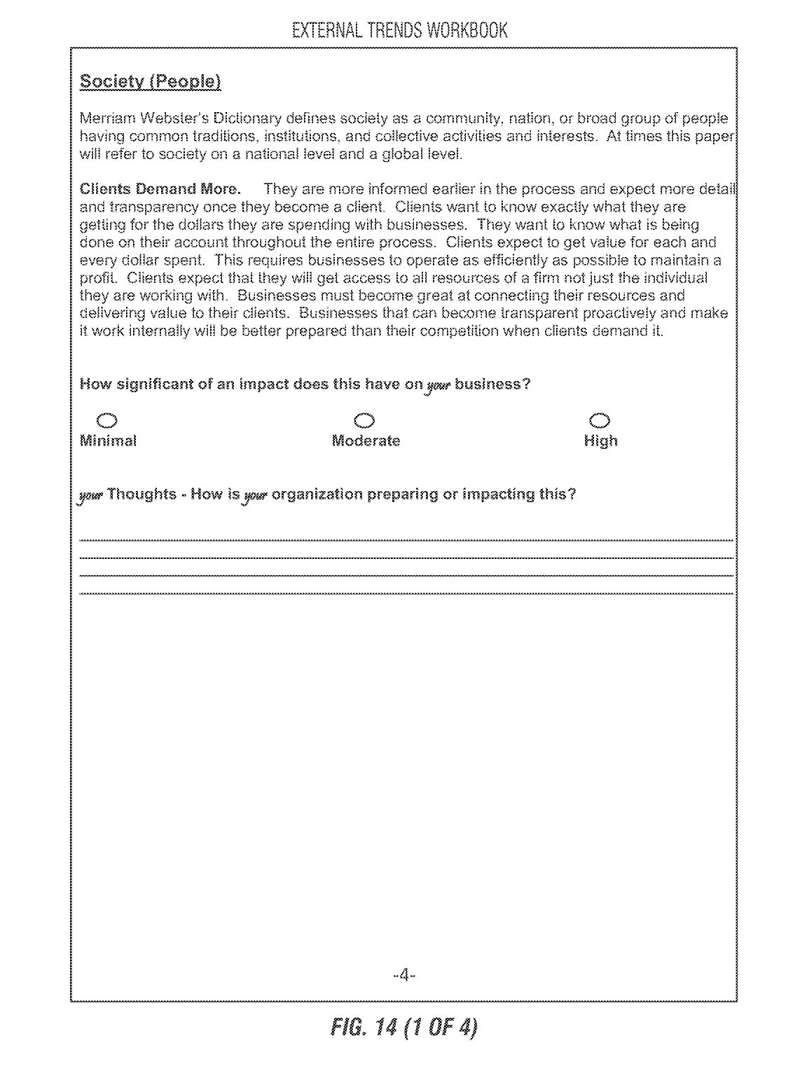

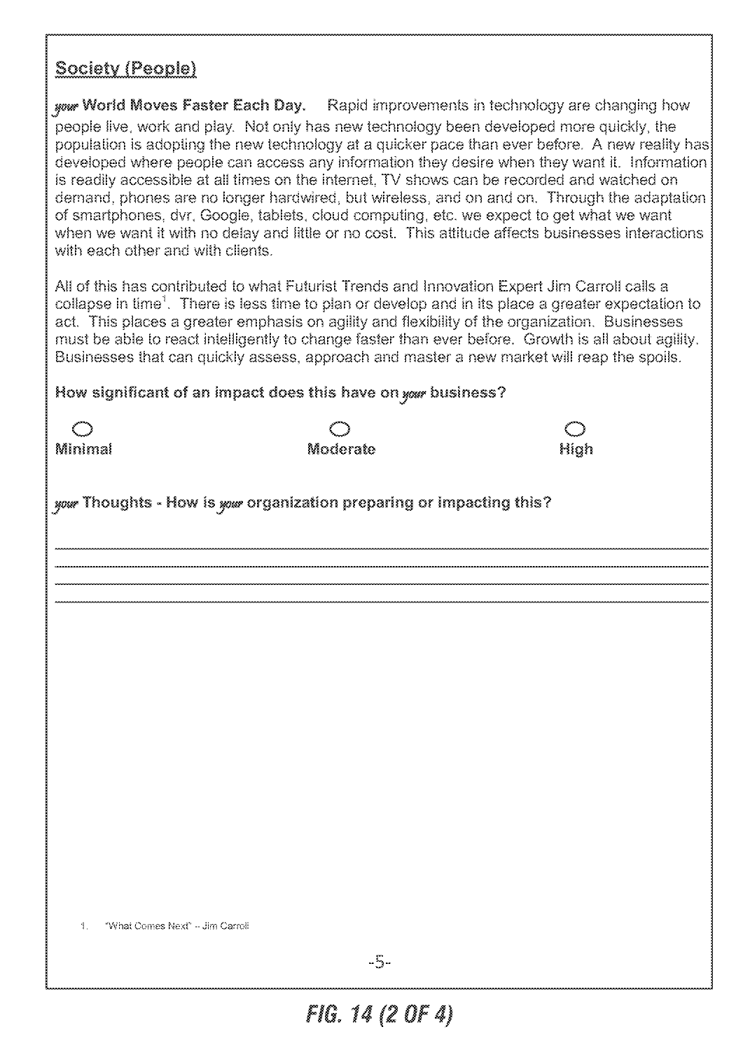

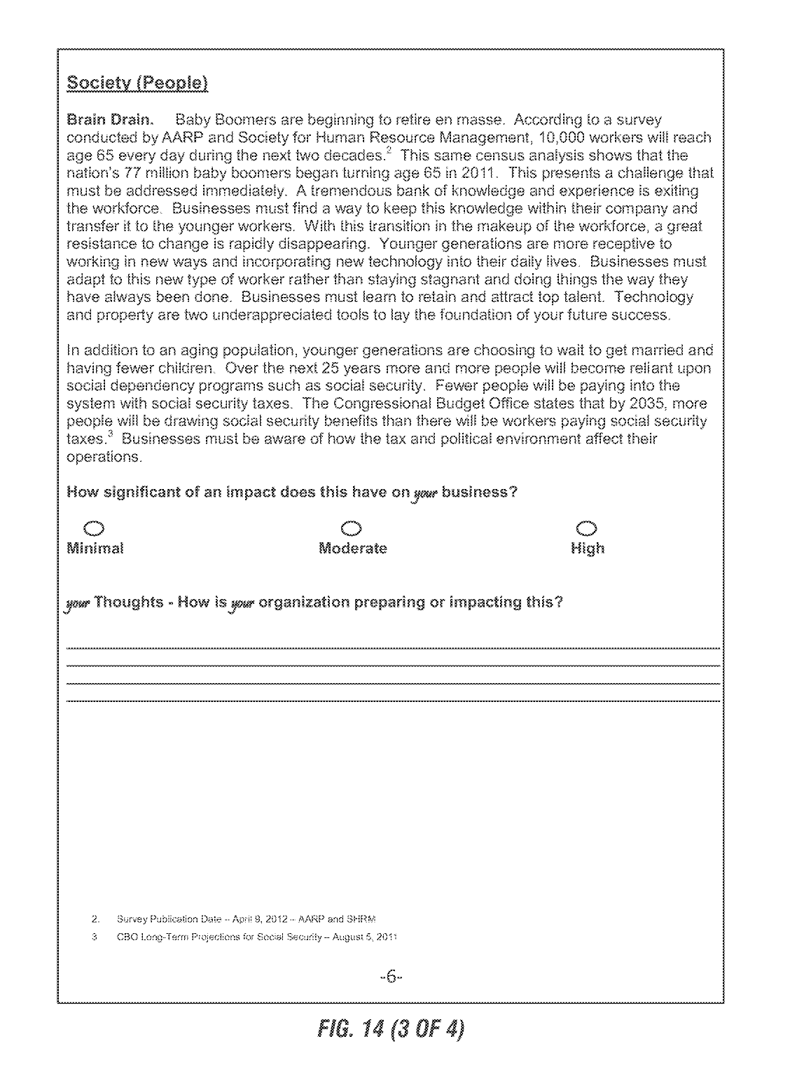

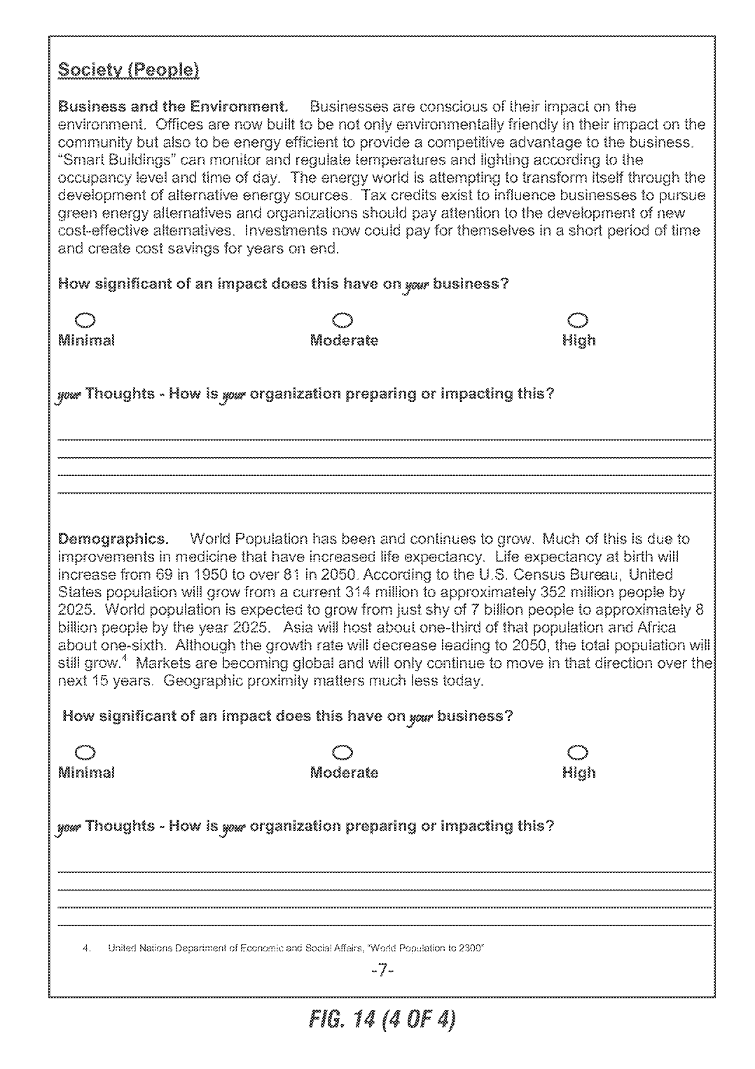

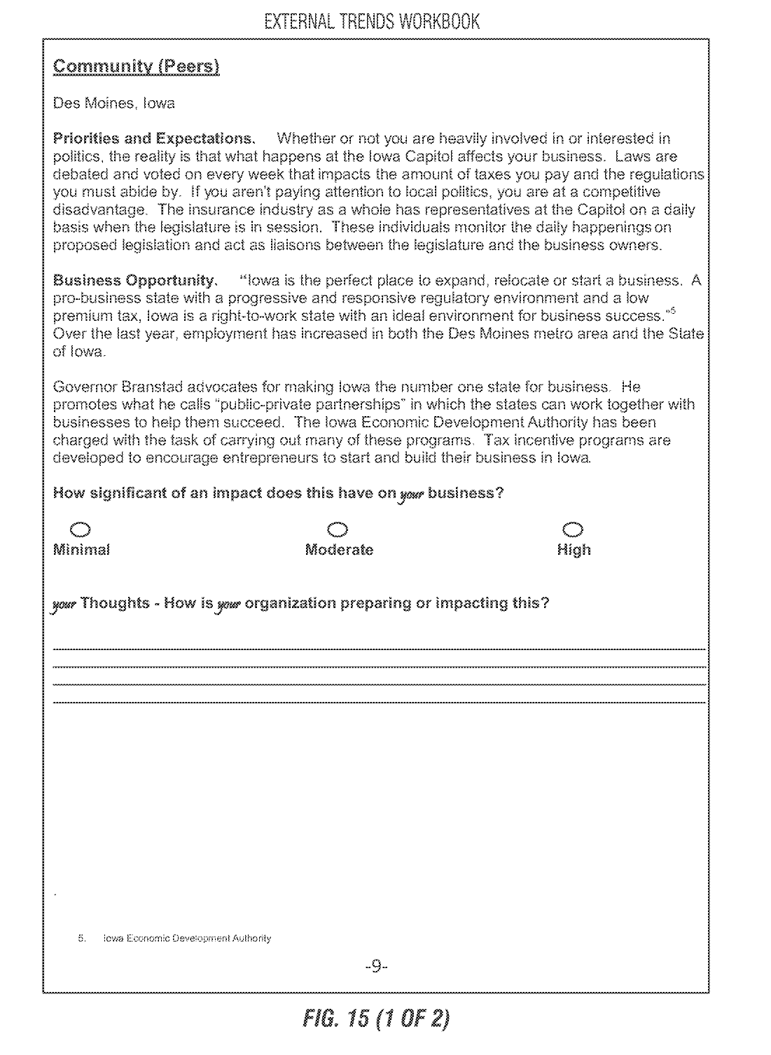

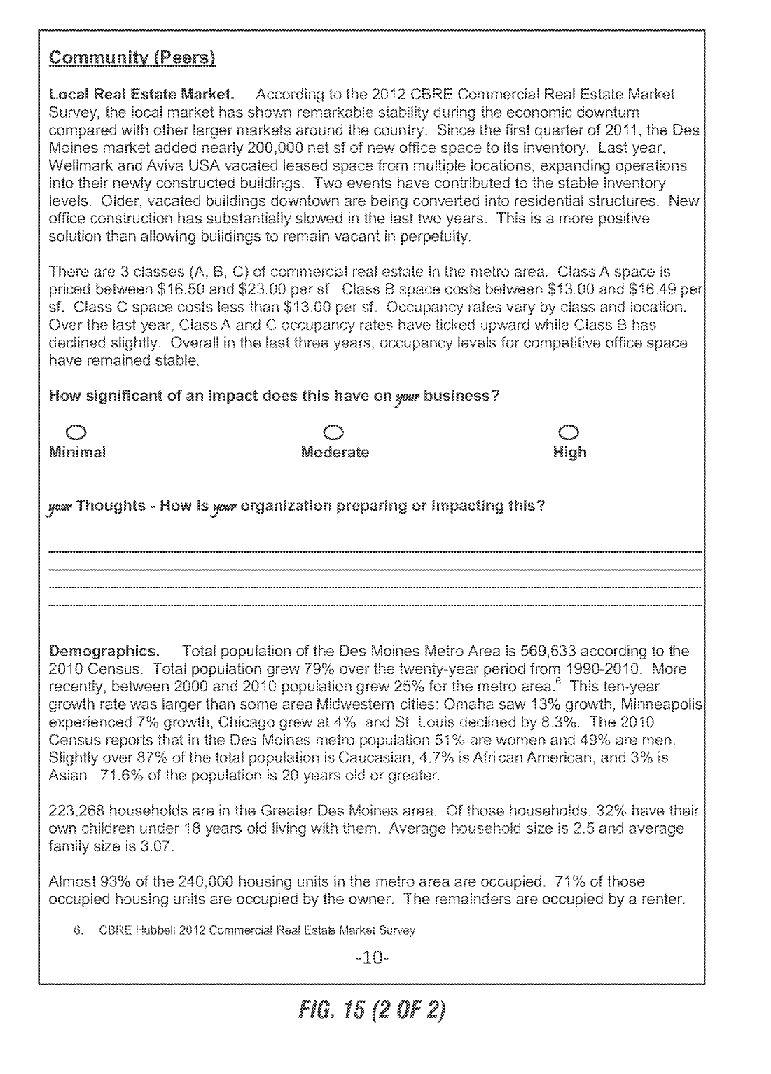

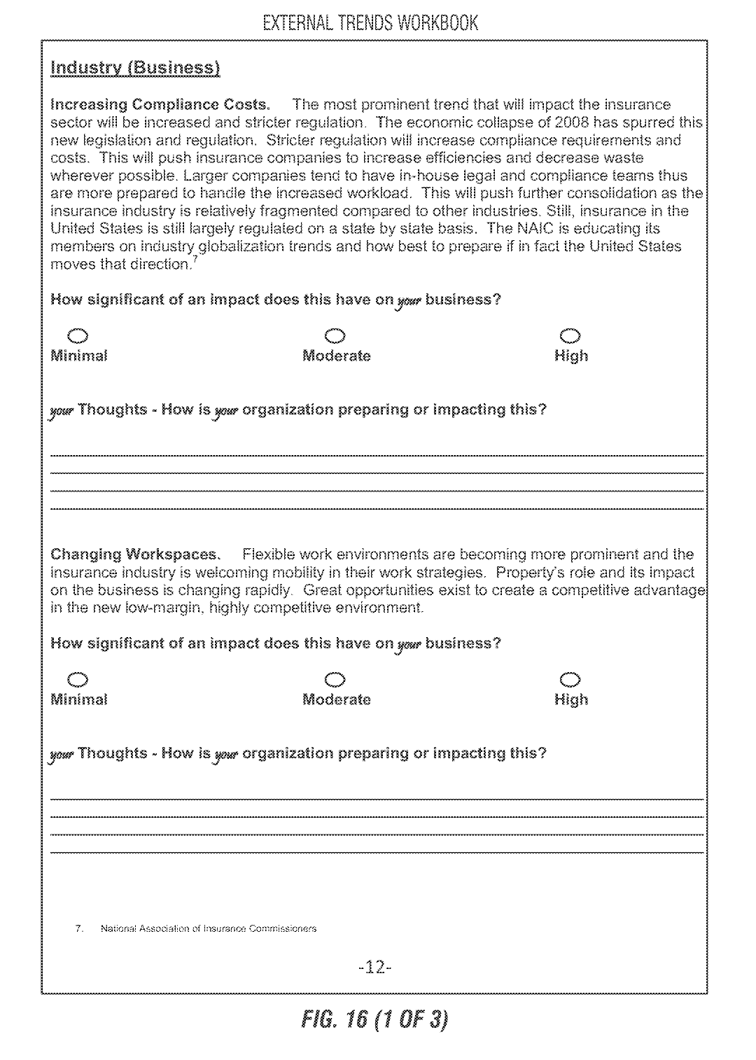

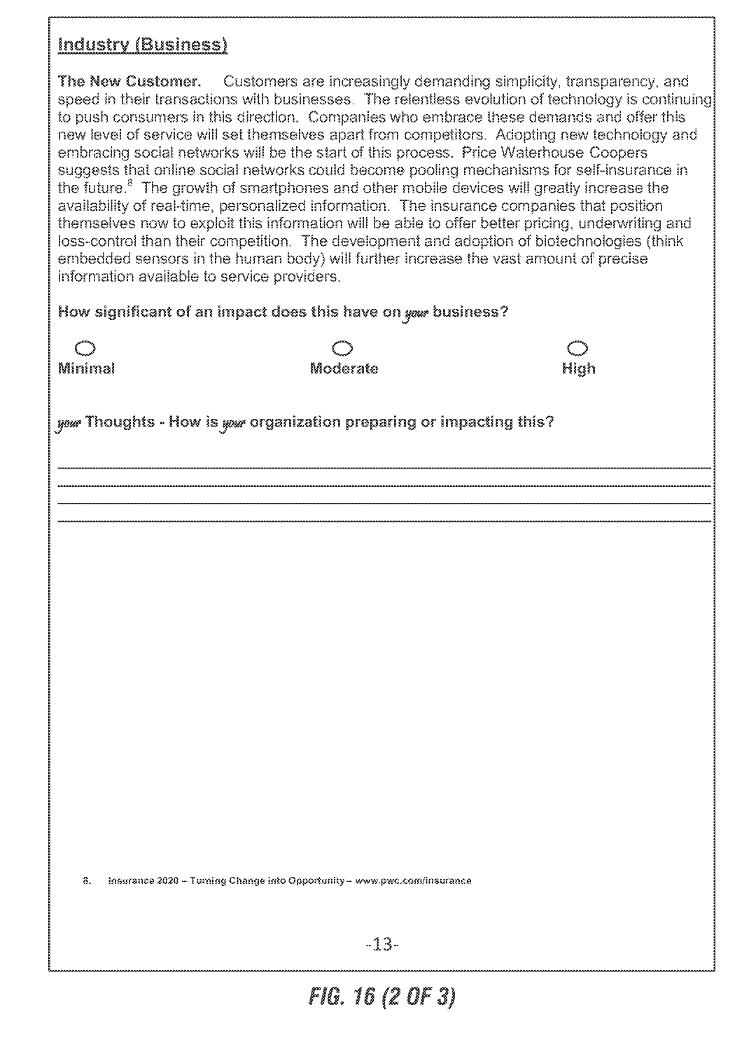

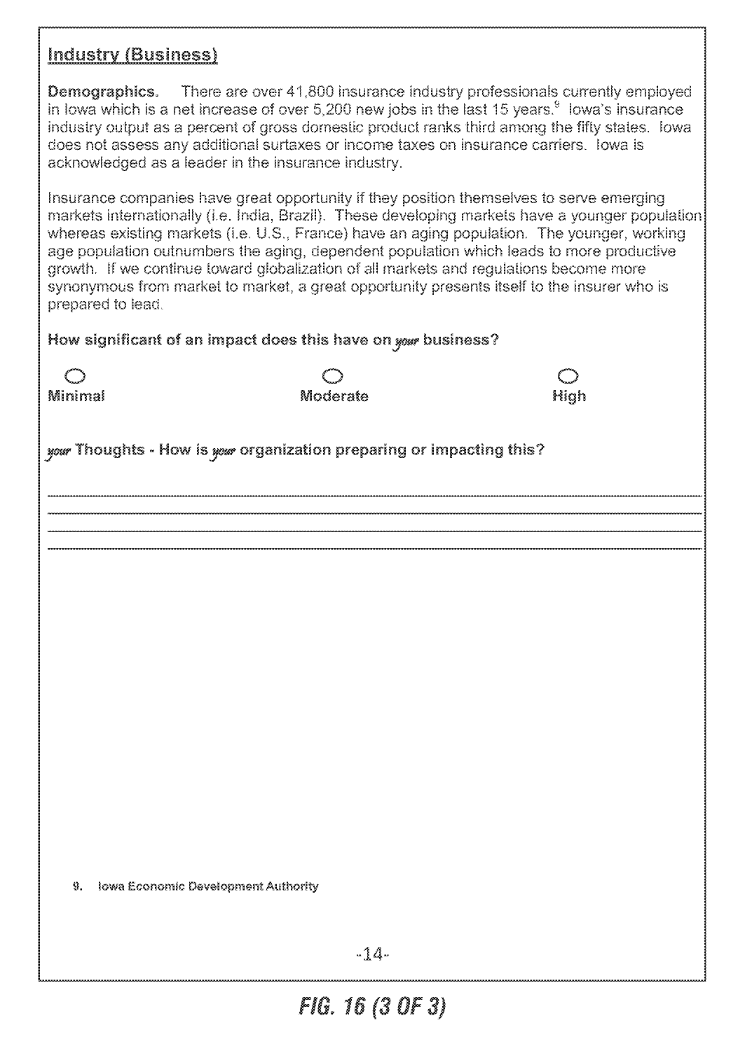

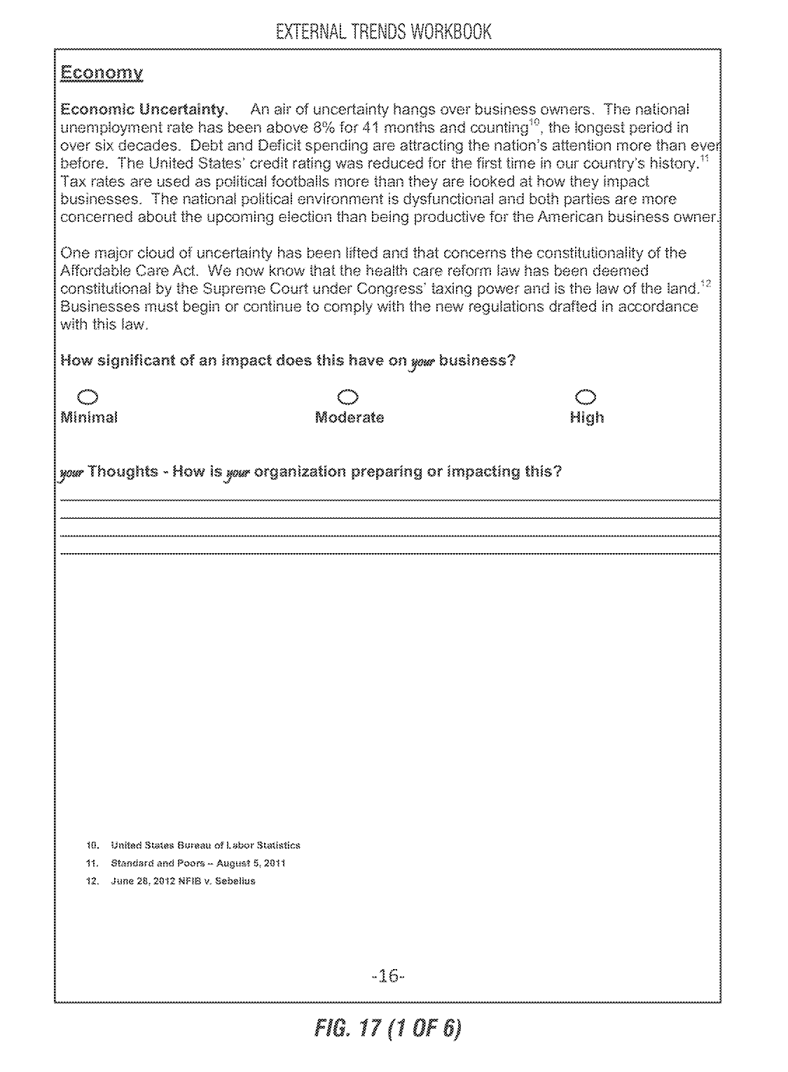

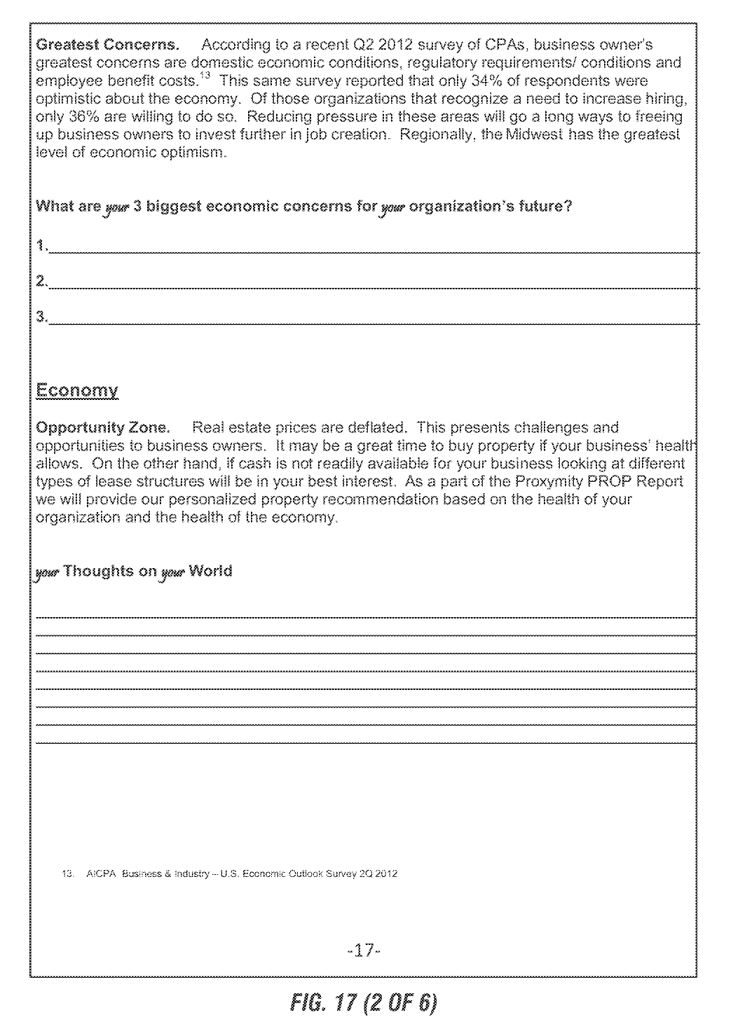

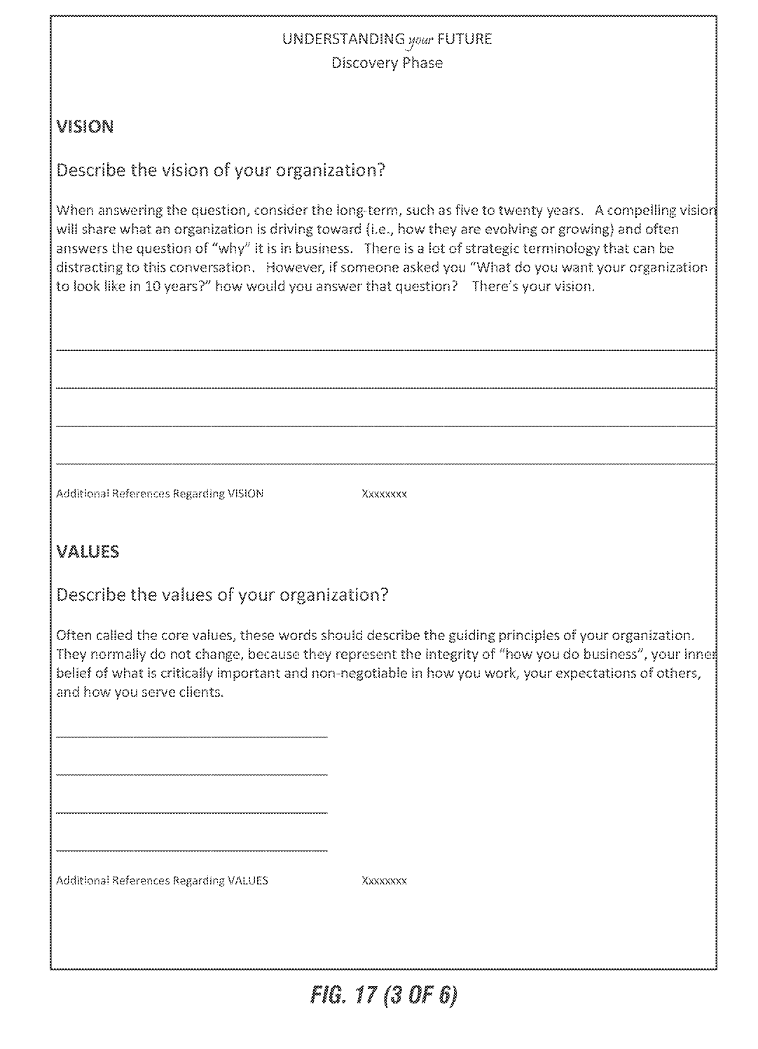

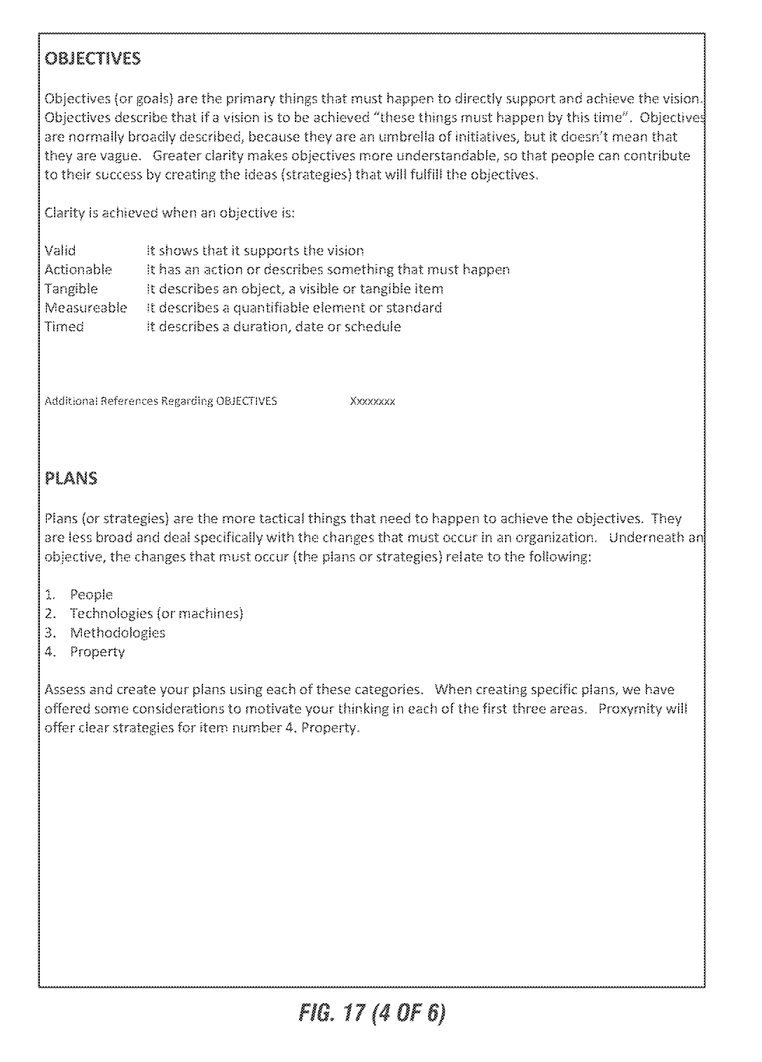

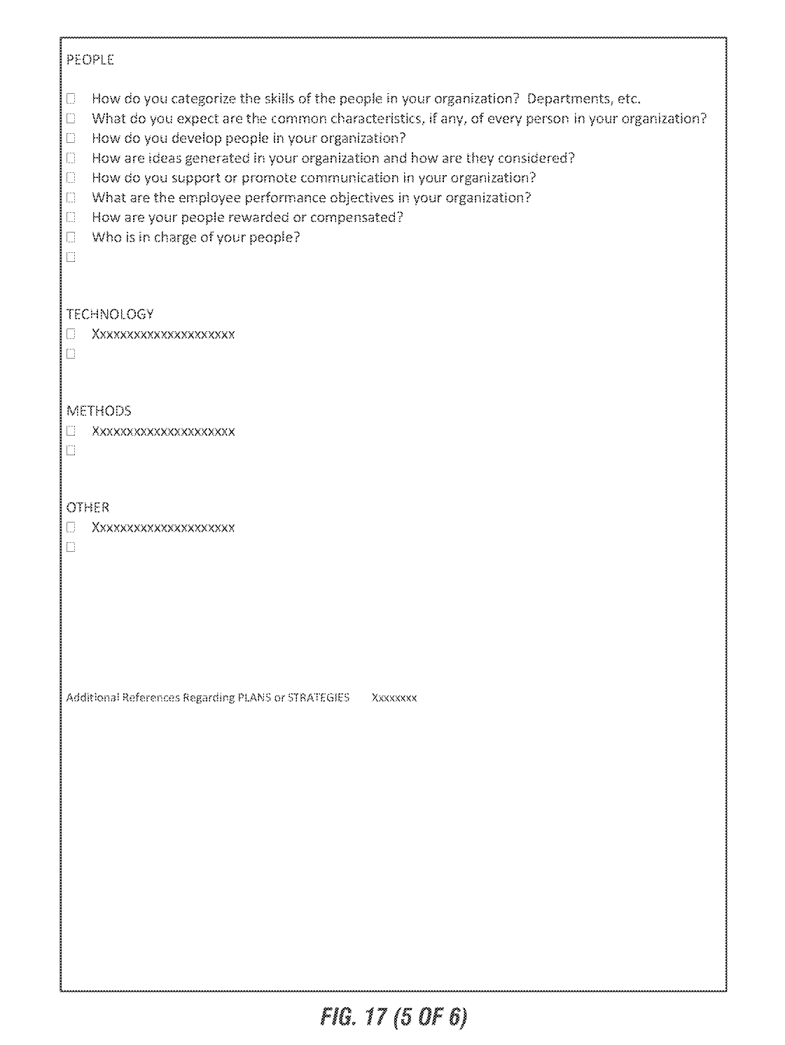

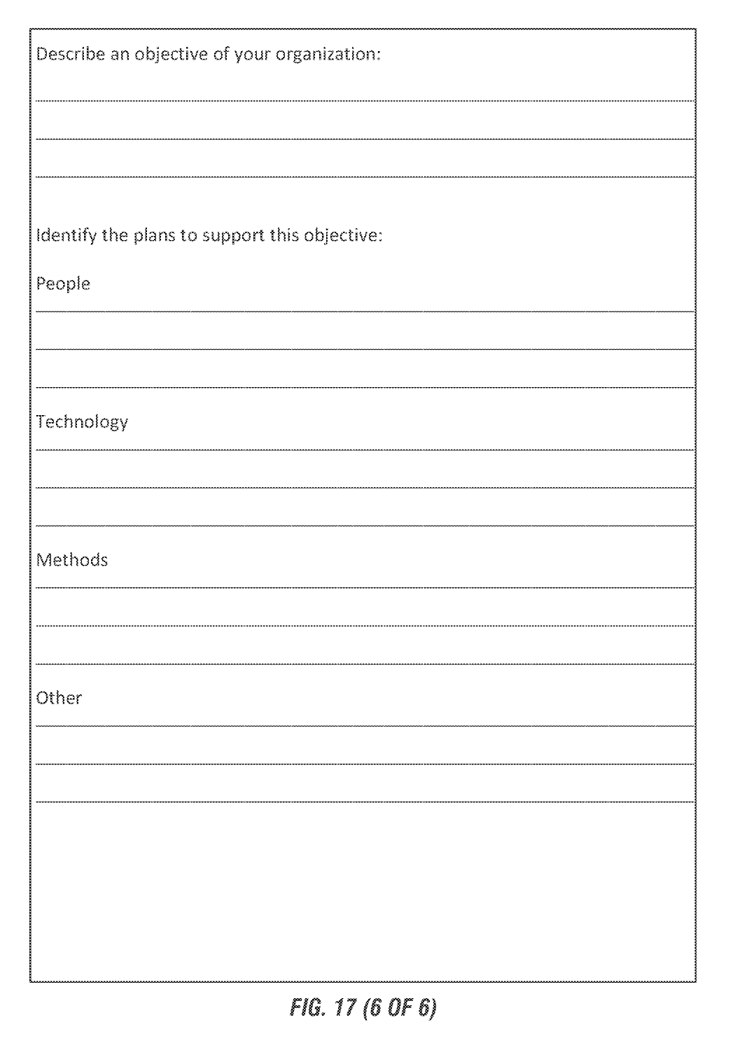

Another important parameter for understanding the risk and opportunities for a business organization is to understand external trends such as research about the changes in commercial property and how they relate to the business or organization in its particular industry. Since these changes result in large part due to changes outside the business or organization (e.g., in the world), research has captured which is unique to the business or organization, for example, by way of a workbook (see FIG. 12 illustrating the table of contents of the external trends workbook). The External Trends Workbook shares research and information with the business or organization and allows the business or organization to respond to each item. The business or organization can then identify each item's relative importance or impact to the business or organization, and make notes that can be used in future work, or to communicate to leaders of the individual categories (e.g., people, technology, vision, property, methods, financials) as they work to form the business or organization strategies. As illustrated in FIG. 11, some external trends that influence or impact a business or organization include, for example, the community in which the business or organization operates, the particular industry in which the business or organization operates, the society in which the business or organization operates, and the economy in which the business or organization operate. The first two, communities and industries, are unique to the business organization whereas societal and economic influences are more universal. Large shifts in society and the economy, however, do have unique impacts to a business or organization. Within each of the four primary influences shown in FIG. 11 are subtopics that need to be explored and understood how they will impact or influence the business or organization. FIGS. 12 and 13 identify subtopics for each of the four primary influences to a business or organization's external trends. For example, attitudes, trends and/or demographics may influence societal changes and priorities/expectations, trends and/or demographics may influence community changes. With regard to industry changes, trends, and/or demographics may influence these changes and with regard to economy changes, attitude and opportunity zone may influence changes within the economy. These subtopics are but a few of the considerations given weight when understanding how society, community, industry and economy impact or influence the external trends of a business or organization. The impact of each of these primary categories and subtopics are further explored in an external trends workbook for which a table of contents is provided at FIG. 12. Each of these four major categories and their sub categories are further explored in the external trends provided, for example, in FIGS. 14-17. Specifically, FIG. 14, pages 1-4, explore the influence or impact of societal changes on a business or organization, FIG. 15, pages 1-2, explore the impact or influence of community (e.g., peers) changes on a business or organization, FIG. 16, pages 1-3, explore the impact or influence of industry (e.g., business) changes on a business or organization, and FIG. 17, pages 1-6, explore the impact or influence of changes in the economy on the business or organization. One of the primary influences on a business or organization affecting it's external trends is the society in which the business or organization operates. Miriam Webster's Dictionary defines society as a community, nation, or broad group of people having common traditions, institutions, and collective activity and interest. In today's world, society can be viewed on a national and/or global level. As indicated on page 1 of 4 in FIG. 14, clients are more informed today than in times past in many of the processes that affect their business or organization. More detail and transparency is expected by a client. A client, for example, wants to know exactly what they are getting for the money that is being spent. They prefer to know what is being done on their account throughout the entire process, and expect to get value for each and every dollar spent. This, for example, necessitates that the business or organization operate as efficiently as possible to maintain a profit. Clients also expect that they will get access to all of the collective resources they are being provided and not just one specific resource, such as for example, provided by an individual being worked with. It is recognized that businesses and organizations must become efficient at connecting their resources and delivering value to their clients. Businesses and organizations that can become transparent proactively and make it work internally are better prepared than their competitors and can immediately act upon client's demands. Other societal changes, such as those illustrated on page 2 of 4 in FIG. 14 include understanding how society will change, and in fact, how fast society may change. A business or organization must be able to react intelligently to change faster and more efficiently than ever before. Understanding a business's ability to react to such changes in society are an important inquiry as part of the external trends workbook. Other inquiries include, such as for example on page 3 or 4 of FIG. 14, understanding the change in the median age of the workforce and the skills present in the up and coming workforce. Understanding also how a business or organization impacts the environment and how its markets are becoming more global, or whether they will continue to move in that direction, are important considerations to understand and are presented as inquiries to the business or organization in the external trends workbook.

The community in which the business or organization operates or performs one or more of its processes or methods also is a primary influencer on the external trends of the business or organization. Pages 1 and 2 of FIG. 15 provide a set of questions or inquiries into the business or organizations perception or understanding how community or the business or organizations peers will influence or impact how the business or organization operates. Understanding these factors within the landscape of community influencers help a business or organization better understand what factors or influencers are important for ensuring that the metrics that support and address a business strategies for growth and profitability are highly correlated with the business's property, the features of the property and the uses and function of the property. For example, understanding the inquiries listed on page 2 of FIG. 15, such as the local real estate market and the demographics of the local market, within which the business or organization operates are key influencers to consider and to better understand the metrics that support and address a business's strategies for growth and profitability so as to highly correlate these with the business's property.

Another key influencer on the external trends of a business or organization is the industry in which the business or organization operates. FIG. 16, pages 1-3, illustrate exemplary inquiries that a business or organization should consider to better understand the industry landscape and how it impacts or influences the strategies of the business relative to increasing their growth and profitability by supporting metrics that are highly correlated with the business's property, the features of the property and the uses and functions of the property. For example, understanding how compliance costs, changing work spaces, customer demands, and/or changing demographics may influence or change the way property is used or plays a role in the methods or processes of the business or organization should be considered to ensure that the metrics that support and address their business's strategies for growth and profitability are highly correlated with the business's property. These, and/or other inquiries, may be proposed in the industry section of the external trends workbook, illustrated, for example in pages 1-3 of FIG. 16.

The economy is also a key influencer on business and how the business or organization intends to use its property to drive metrics that support and address the business's strategies for growth and profitability and ensure that these are highly correlated with the business's property, the features of the property and the use and function of the property. Pages 1-6 in FIG. 17 provide exemplary inquiries into a business or organization's understanding of how the economy may impact or influence the business's use of property as a strategy for ensuring that use, function and features of the property are aligned with the business's strategies for growth and profitability. For example, economic uncertainty, regulatory requirements, employee benefits, real estate prices, etc. may all impact or influence a business's strategy for growth and profitability.

In addition to understanding the business or organization's current status, its external trends to identify its risks and opportunities requires an understanding of where the business or organization intends to go or its future endeavors. Pages 3-6 of FIG. 17 provide inquiries for the business or organization to consider eliciting an understanding of the business or organization's future through a discovery phase process. Some key considerations, for example, for the business or organization to consider in understanding their future through the discovery phase process is to identify and provide an understanding of the vision of the business or organization, the values of the business or organization, the objectives of the business or organization, the plans of the business or organization, and the people needed to implement each of these.

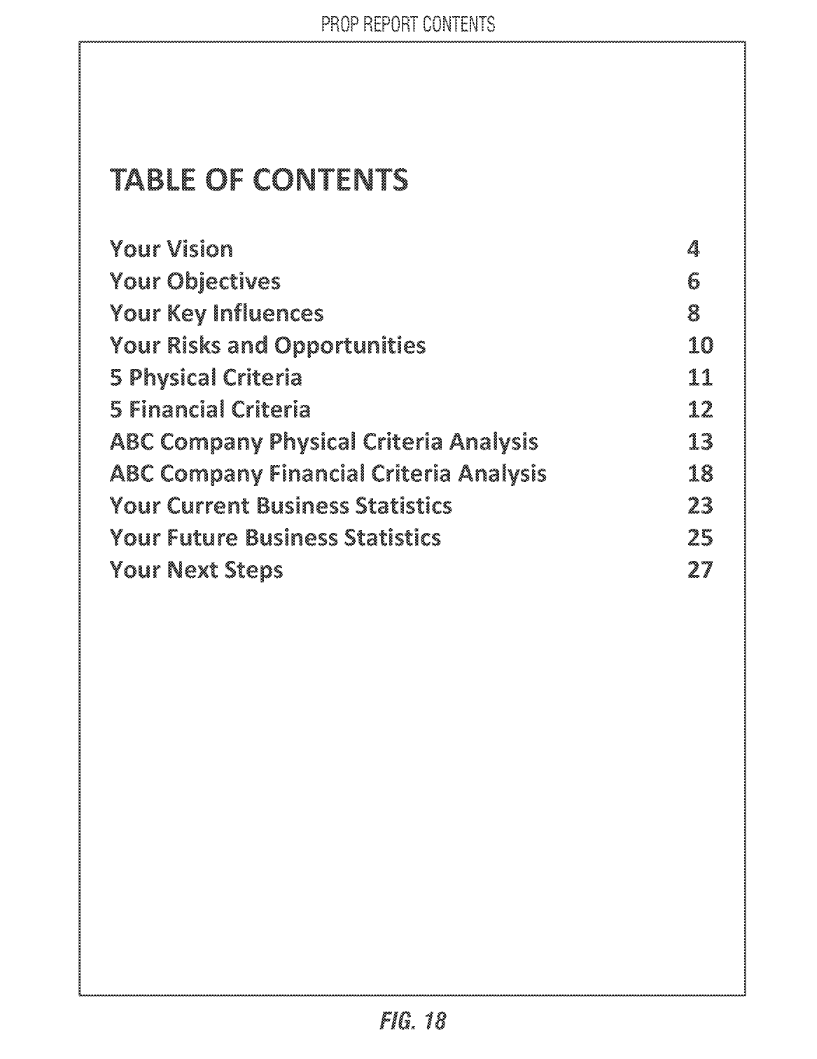

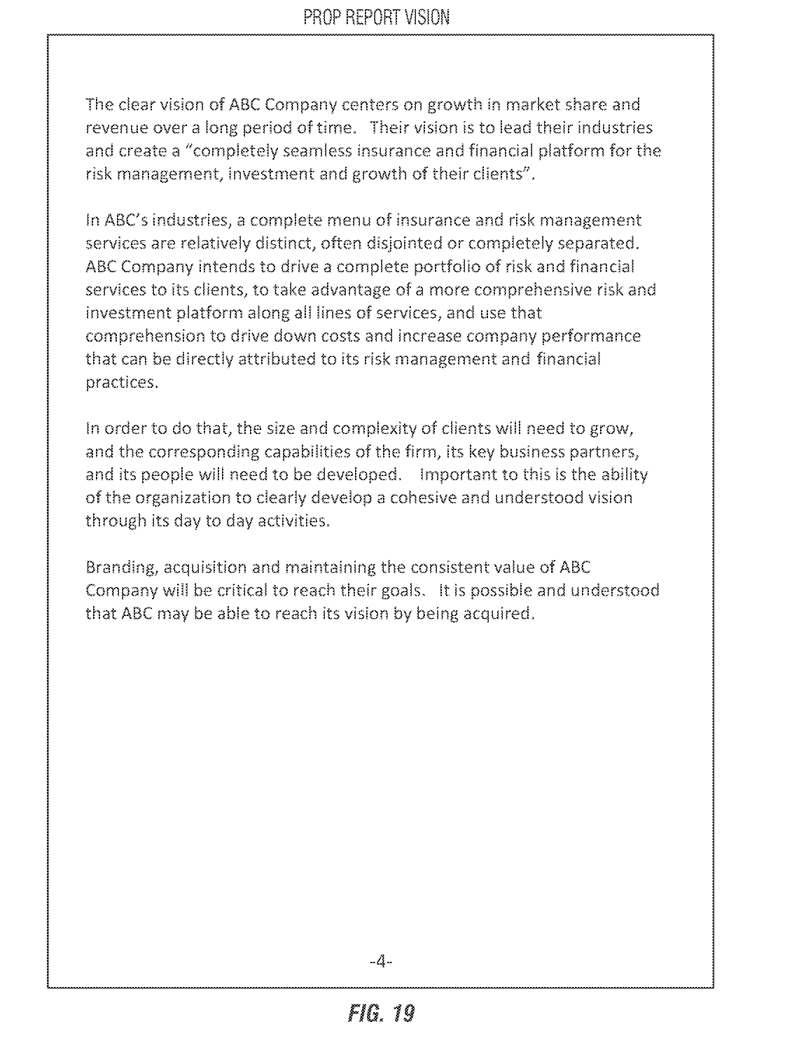

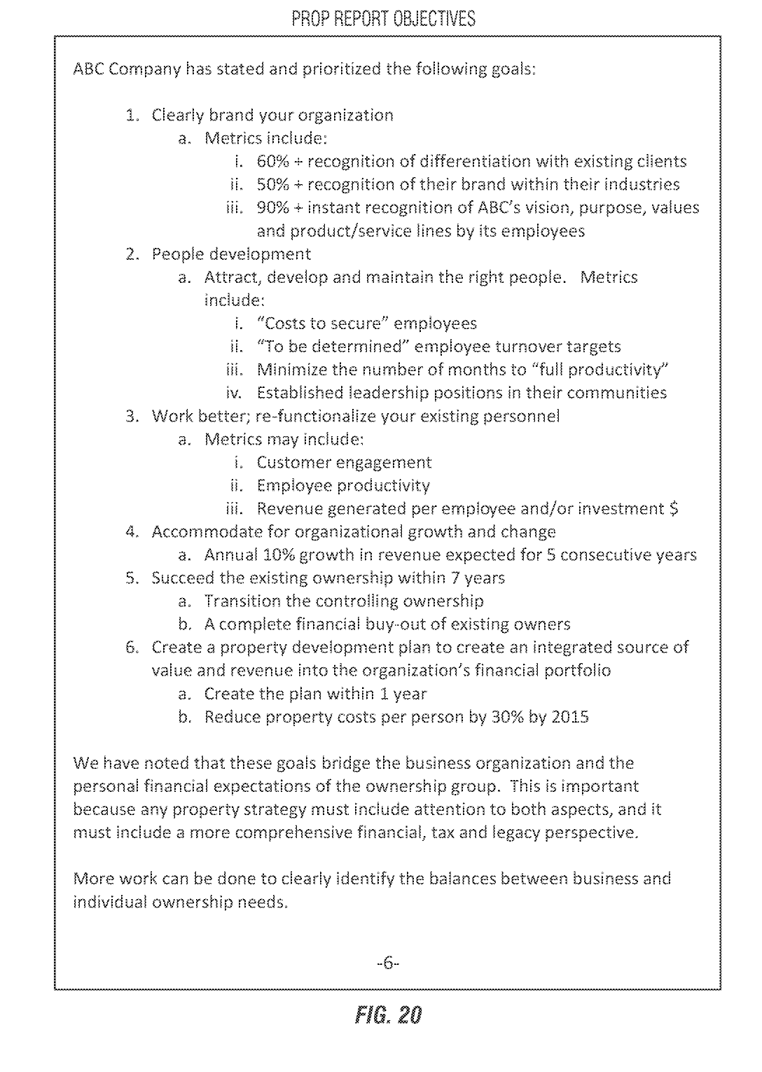

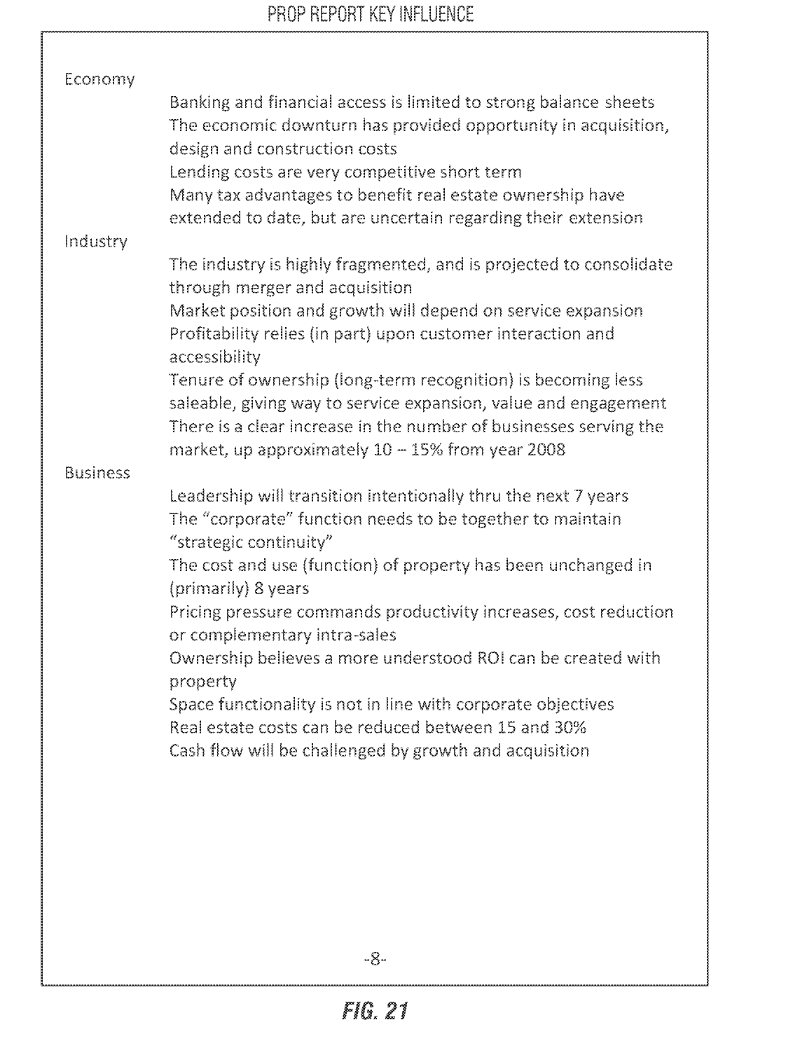

Based on the information provided in the workbook by the business or organization a PROP plan is developed, provided and presented to the business or organization, which provides a strategizing method for ensuring that the metrics that support and address the business or organization's strategies for growth and profitability are highly correlated with the business's property, the features of the property and the uses and function of the property. FIG. 18 provides an exemplary table of contents for a PROP report. Included, for example, in the PROP report is the vision, objectives, key influences, risks and opportunities for the business or organization. Also included are the five physical criteria and five financial criteria that drive the PROP report analysis along with a physical and financial criteria analysis. The PROP report also includes business statistics for both current and future purposes and a section addressing the next steps for the business or organization based on the findings and recommendations in the PROP report. The pages indicated in the PROP report table of contents in FIG. 18 correspond with the pages in the subsequent figures, specifically FIGS. 19-27. According to one exemplary aspect, the PROP report may include a section such as illustrated in FIG. 19 setting forth the vision of the company of the business or organization also identified by way of example or key points that define the vision of the business or organization based on the workbook analysis provided in the foregoing figures and description. As illustrated in FIG. 20, the company or organization's stated and prioritized goals are identified and some analysis, for example, may be provided relating to these goals and how they meet the organization or business's strategies for growth and profitability using property as a means for, at least as one medium, for achieving the business's goals.

FIG. 21 identifies, for example, the key influencers relating to the economy, the industry in the business in which the organization or company is involved. An analysis may be provided for each of these key influencers based on the information provided in the foregoing workbook by the business or organization.

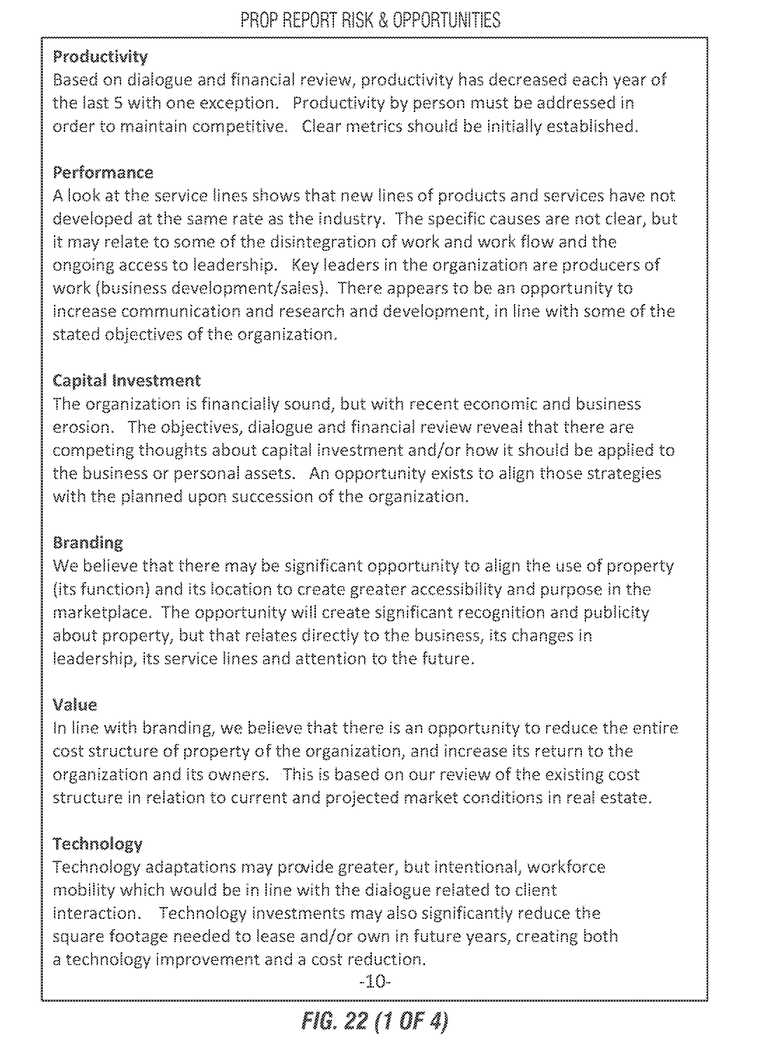

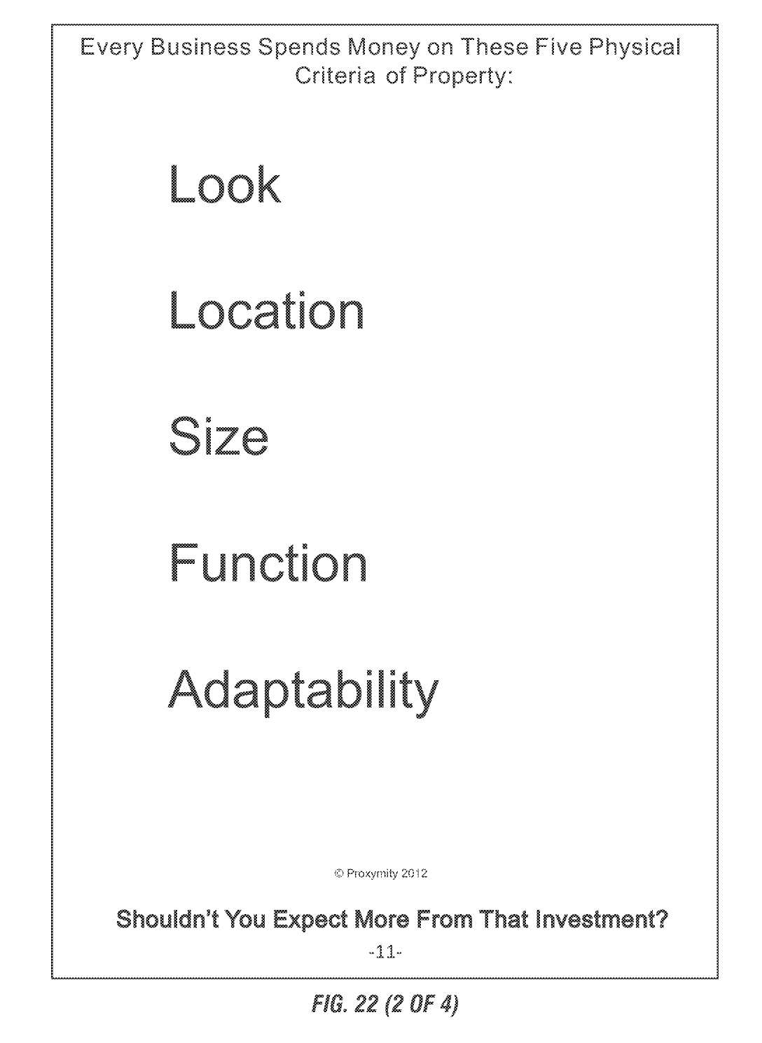

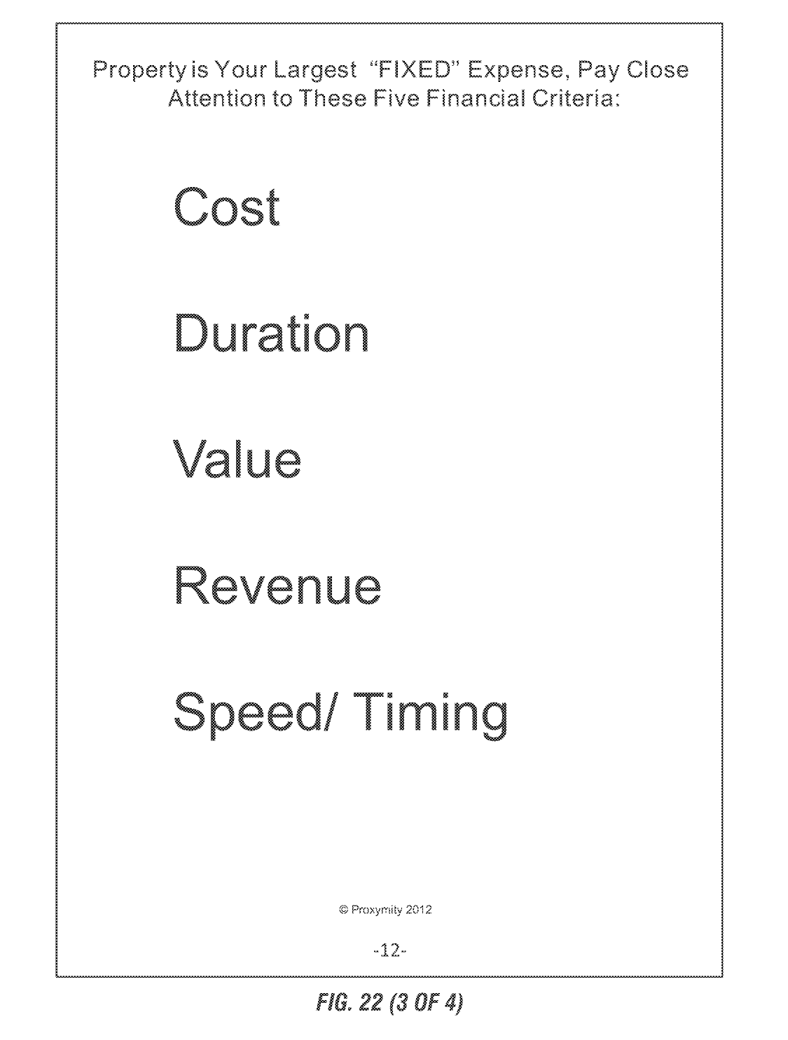

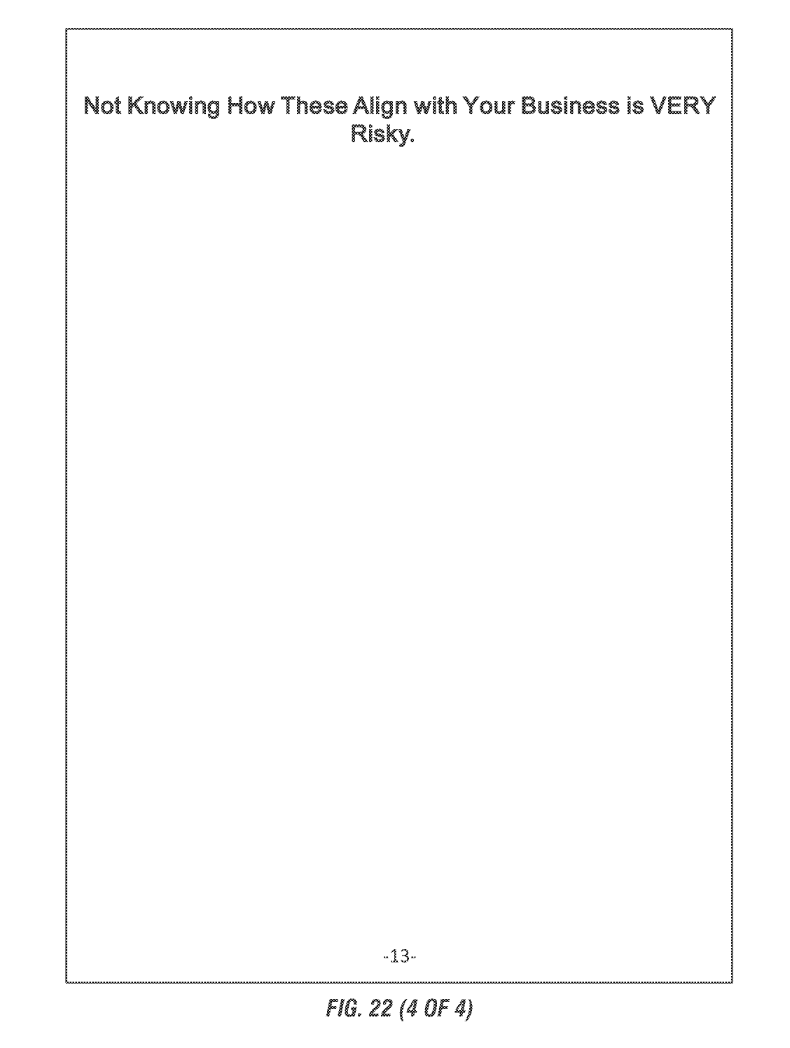

FIG. 22 identifies the risks and opportunities associated with the business or organization. Specific factors, such as productivity, performance, capital investment, branding, value and/or technology are analyzed and an explanation for each is provided on how they may impact or influence a business or organization's strategies for growth and profitability to ensure that these are highly correlated with the business's property, the features of the property and the uses and functions of the property. Pages 2 and 3 of FIG. 22 identify the five core physical criteria of property in the five core financial criteria of a property and provide analysis of each. For example, the five core physical criteria of a property are addressed on page 2 of FIG. 22 and the five core financial criteria of the property are identified on page 3 in FIG. 22. It is understood that a business spends money on these key physical and financial criteria of a property. Physical criteria include, for example, the look, location, size, function and adaptability of the property whereas financial criteria include the cost, duration, value, revenue, speed/timing of the property. Each of these criteria are analyzed to provide the business or organization with a strategy for growth and profitability that is highly correlated to the business's property, the features of the property and the uses and function of the property by recommending a selected property, a set of potential uses and functions of the select property and one or more features of the selected property independent of any interest of the recommending party in the selected property or features.

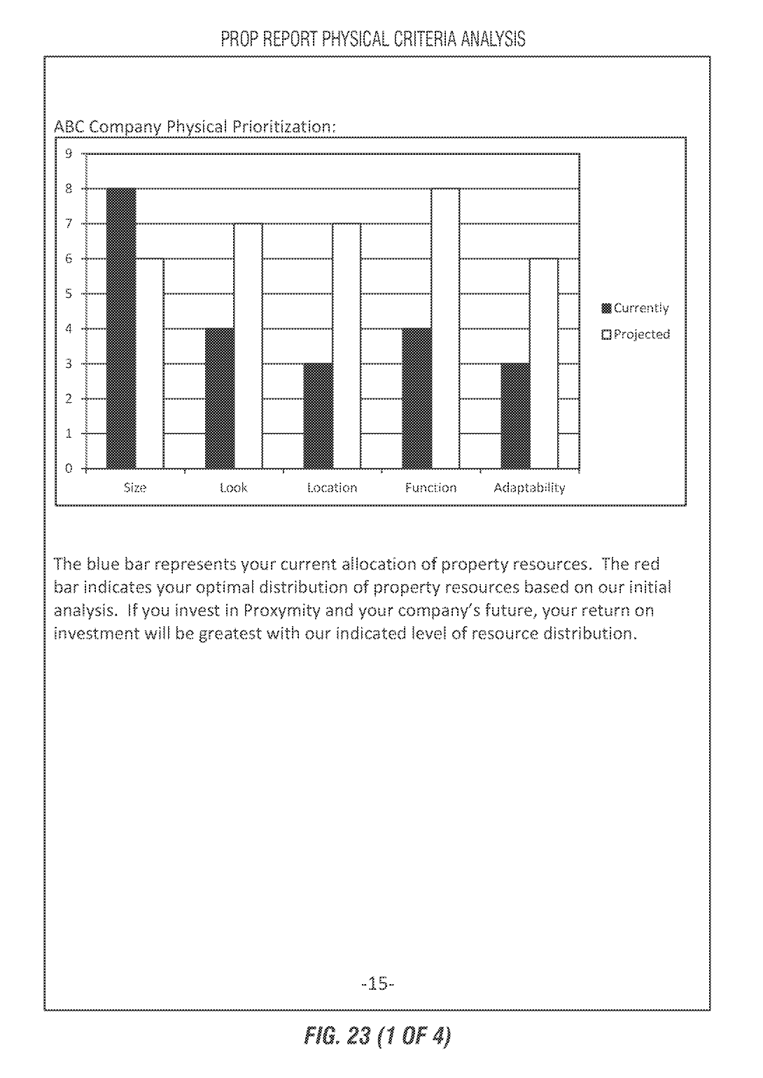

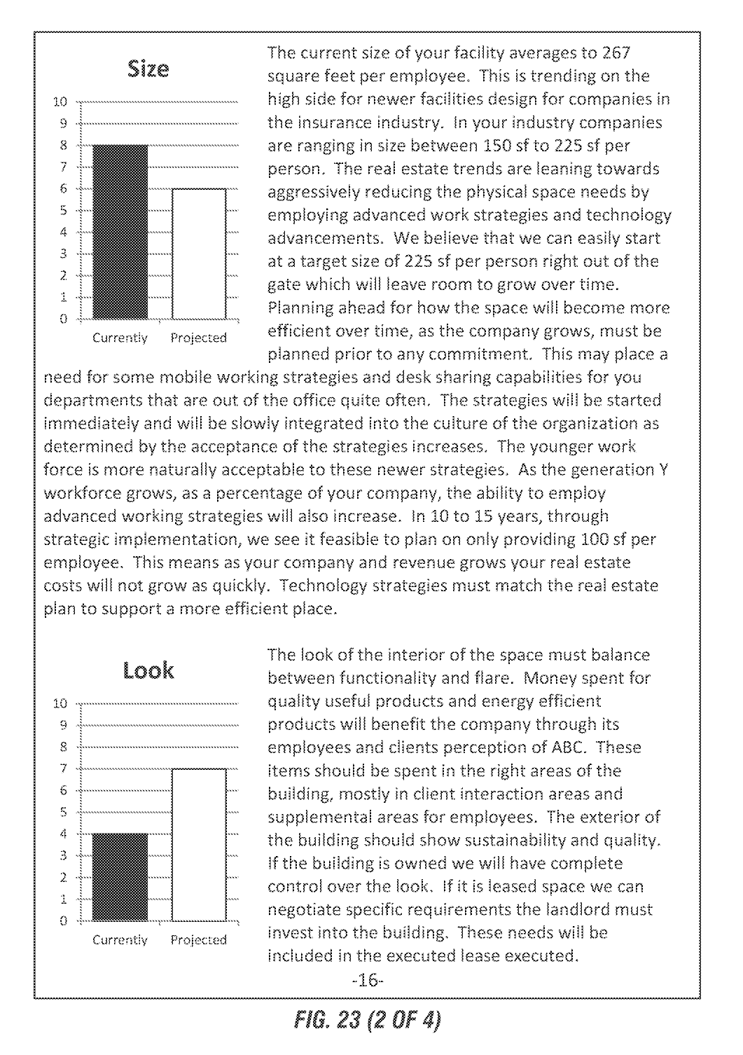

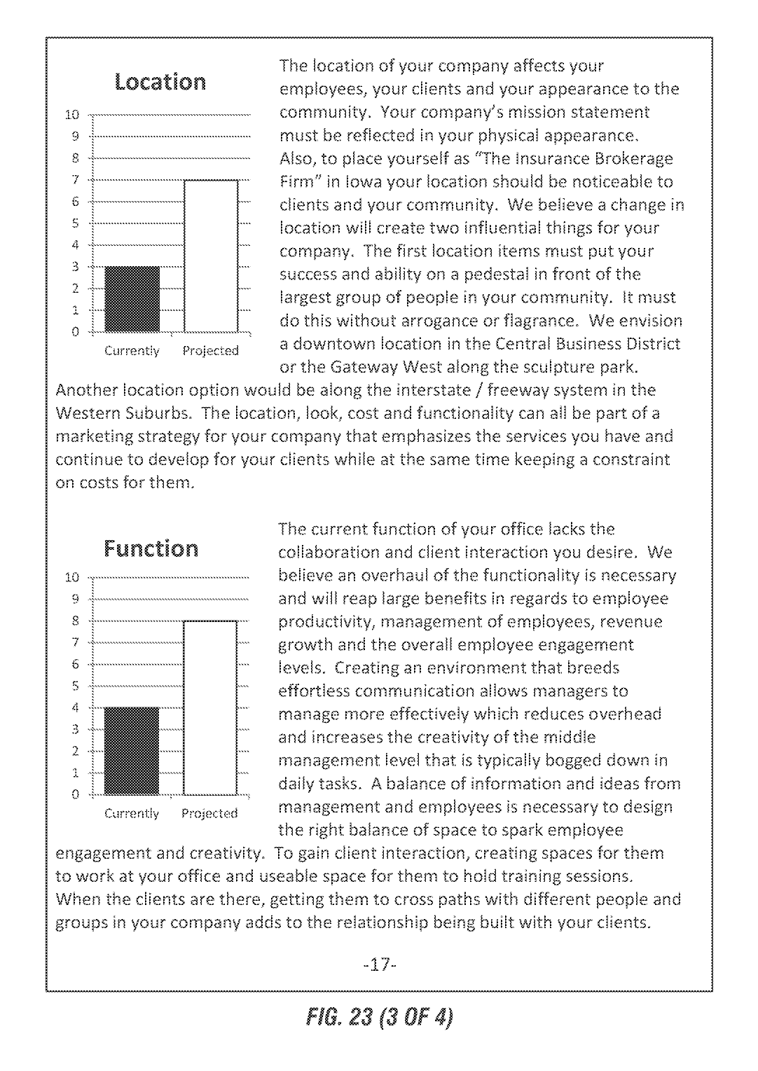

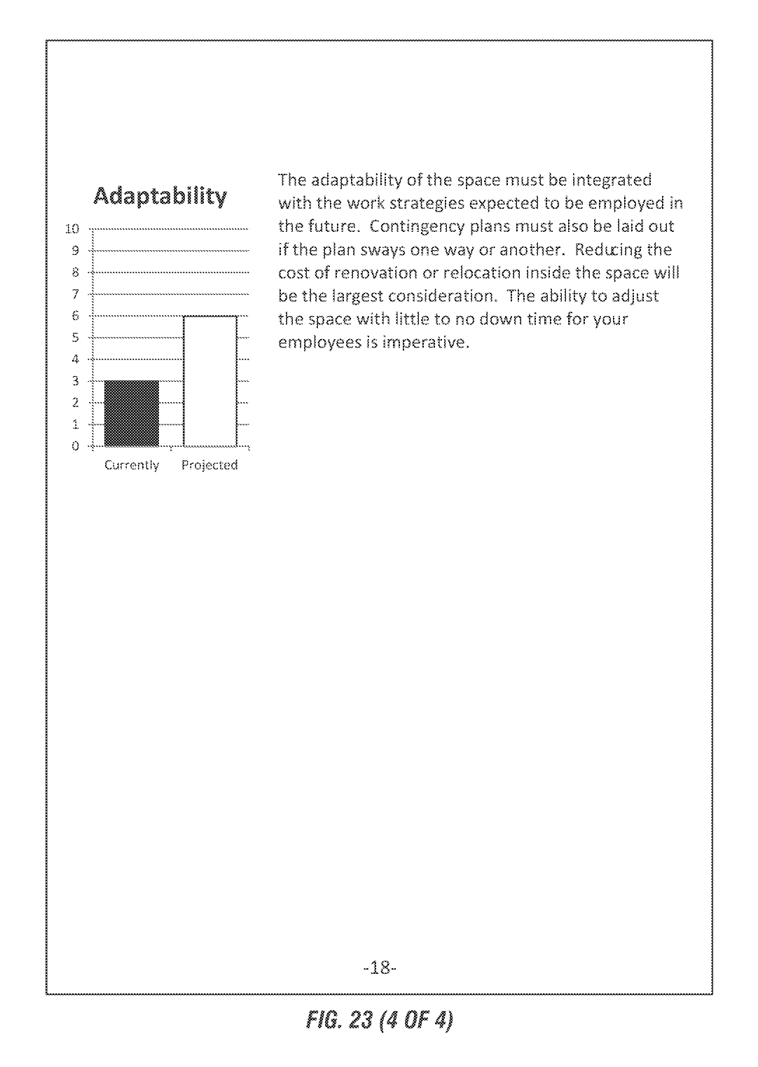

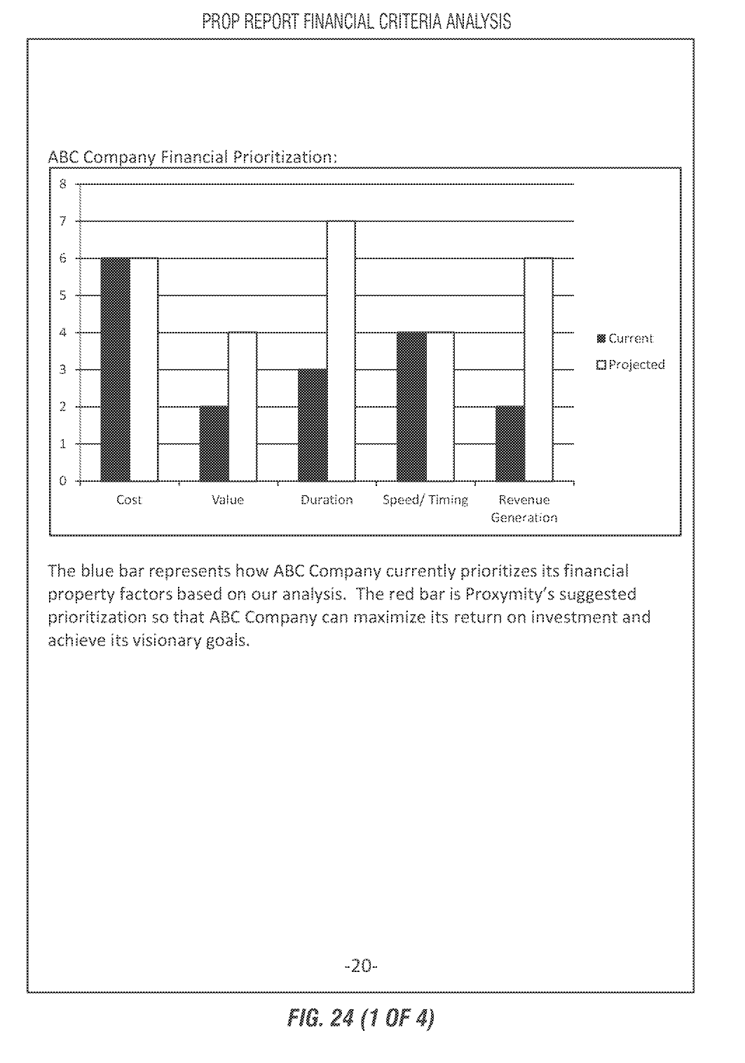

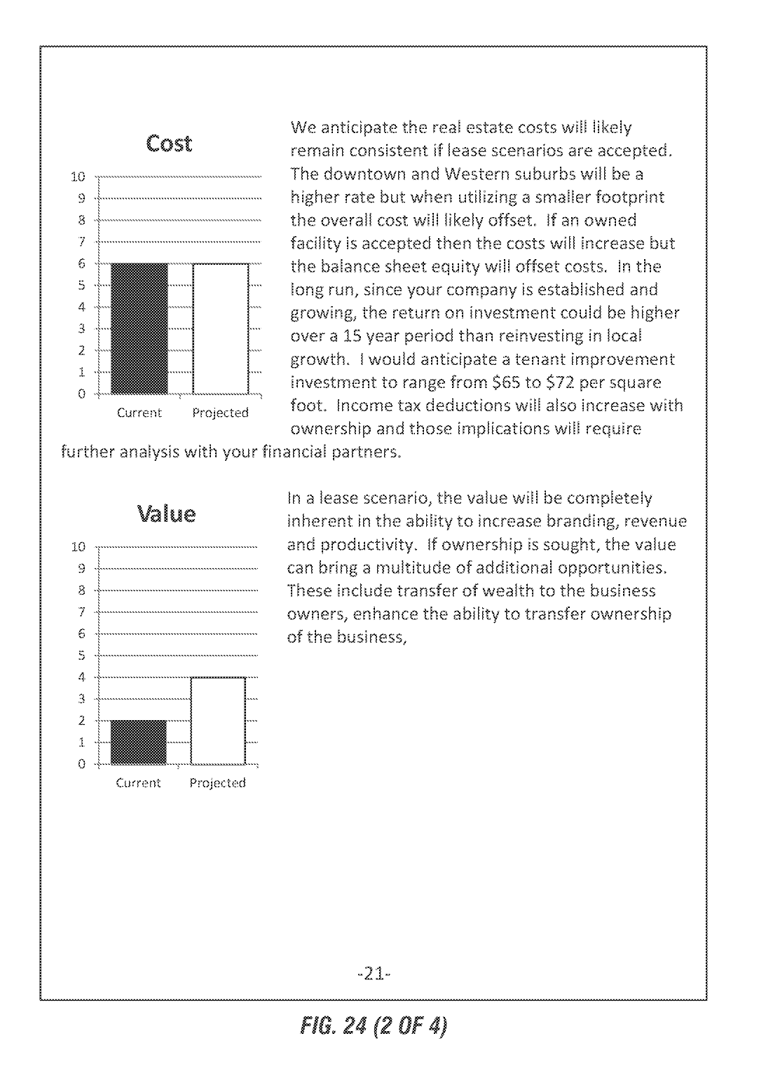

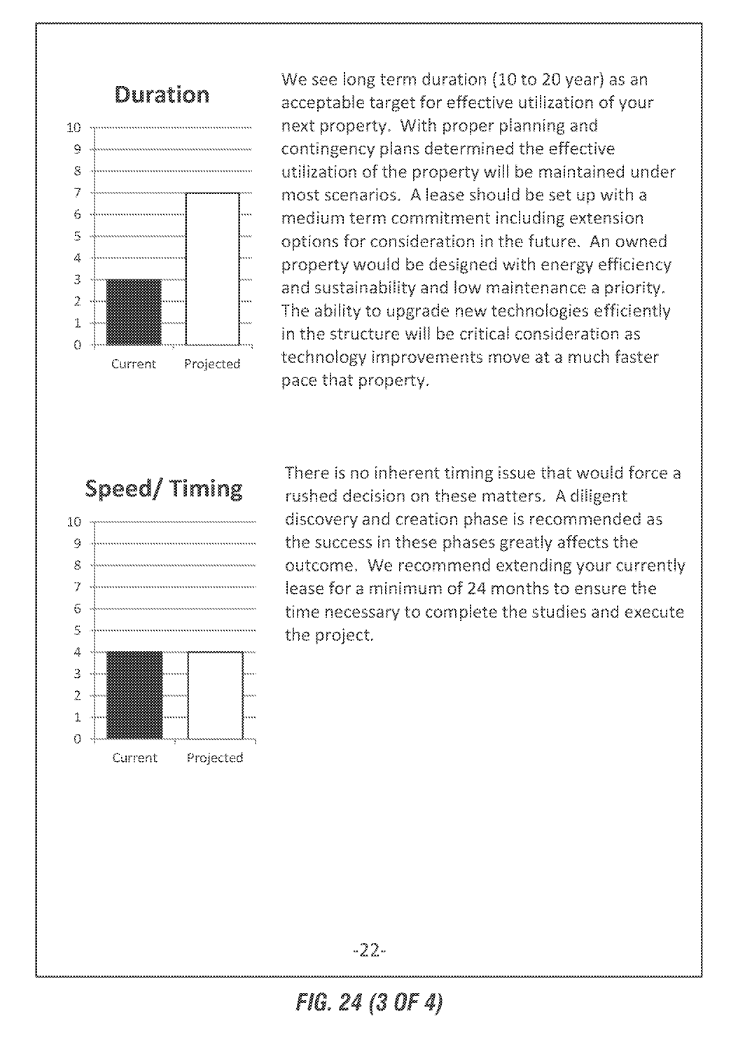

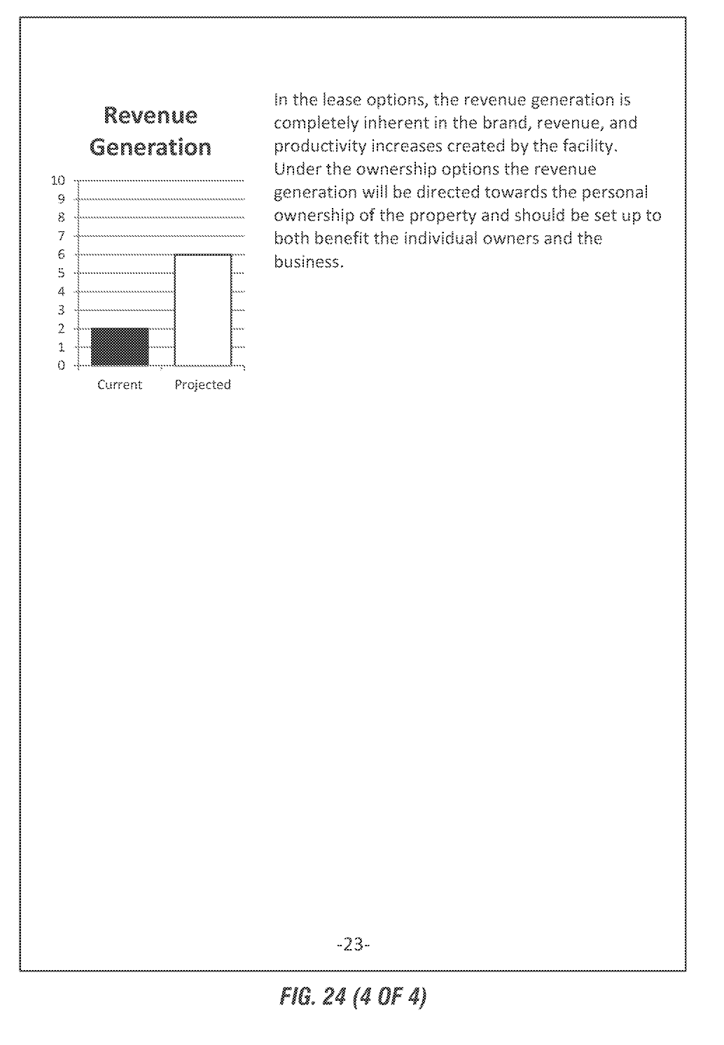

FIG. 23, namely pages 1-4, provide information regarding an exemplary physical property analysis. For example, on page 1 of 4 in FIG. 23, physical prioritizations are shown for an exemplary company, ABC Company, by way of a bar graph which represents the current allocation of the company's property resources. The white bars represent the optimal distribution of property resources based on an analysis provided to the company or organization whereas the black bars represent the current allocation of property resources for the business or organization. Investing in the property resources based on the redistribution shown in FIG. 23 a business or organization is able to ensure a higher correlation with its growth and profitability and the business's property, the features of the property and uses and function of the property. The bar charts and analysis provided on pages 2, 3 and 4 of 4 addresses a business or organization's property looking at factors such as size, look, location, function and/or adaptability. Each of these factors are illustrated showing the business or organization's current allocation to each with an adjusted or projected allocation based on the redistribution of investment by the business or organization and to each so as to provide a higher correlation between the business's strategies for growth and profitability using a highly correlated property, highly correlated features of the property and highly correlated uses and functions of the property. Similarly, FIG. 24, specifically pages 1, 2, 3 of 4, provide an exemplary financial prioritization for ABC Company. This is but one example of a financial prioritization using a fictitious company (i.e., ABC Company) by way of illustration and example. On page 1 of 4 in FIG. 24, a financial prioritization for ABC Company is shown with the current prioritization of the company's financials in black and the redistribution of the company's financials in white so that the company can maximize its return on investment and achieve its visionary goals. The redistribution of financial priorities helps the business or organization ensure that the metrics that support and address the business or organization's strategies for growth and profitability are highly correlated with the business's property, the features of the property, and the uses and function of the property by recommending a selected property, a set of potential uses and functions of the selected property and one or more features of the selected property such as costs, value, duration, speed/timing, and/or revenue generation as illustrated in FIG. 24. Pages 2, 3 and 4 of 4 in FIG. 24 provide additional analysis of each of the financial cost factors such as costs, value, duration, speed/timing, and revenue generation. Each illustrates the business's current financial prioritization and the recommended or projected financial prioritization to achieve or ensure that the metrics that support and address the business or organization's strategies for growth and profitability are highly correlated with the business's property, the features of the property, and uses and functions of the property.

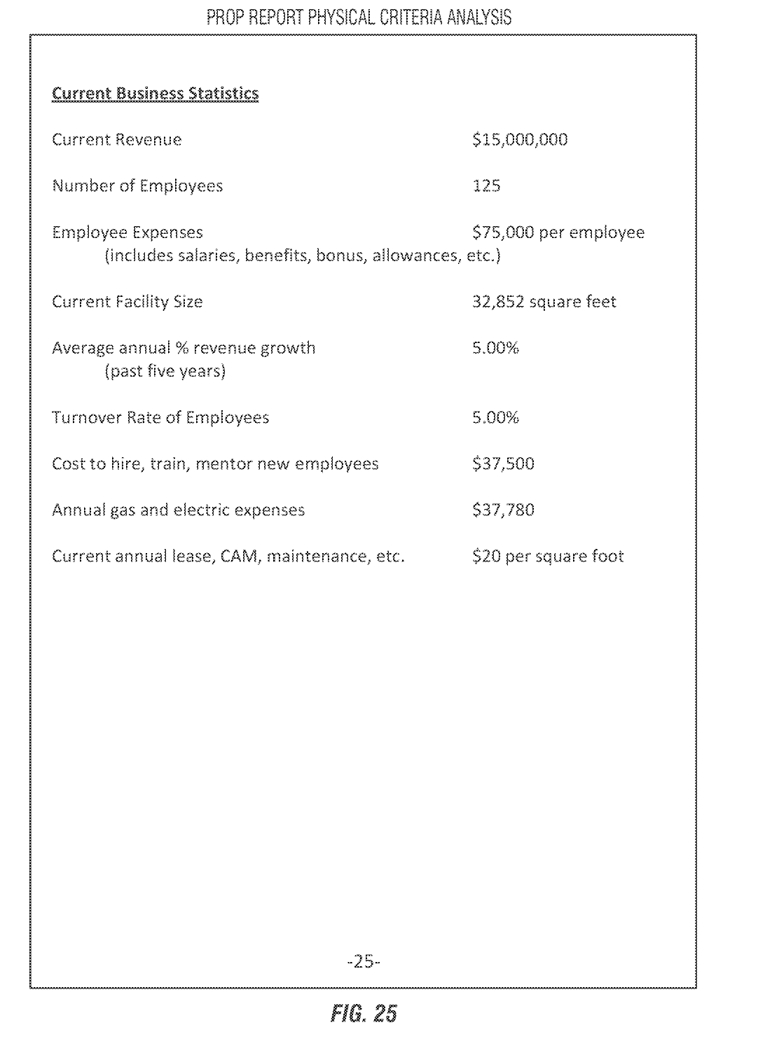

FIG. 25 provides an exemplary statistical analysis for the business or organization providing such information as current revenue, number of employees, employee expenses, current facility size, average annual percent revenue growth, turnover rate of employees, cost to hire, train, mentor new employees, annual gas and electric expenses, current annual lease, CAM, maintenance, etc.

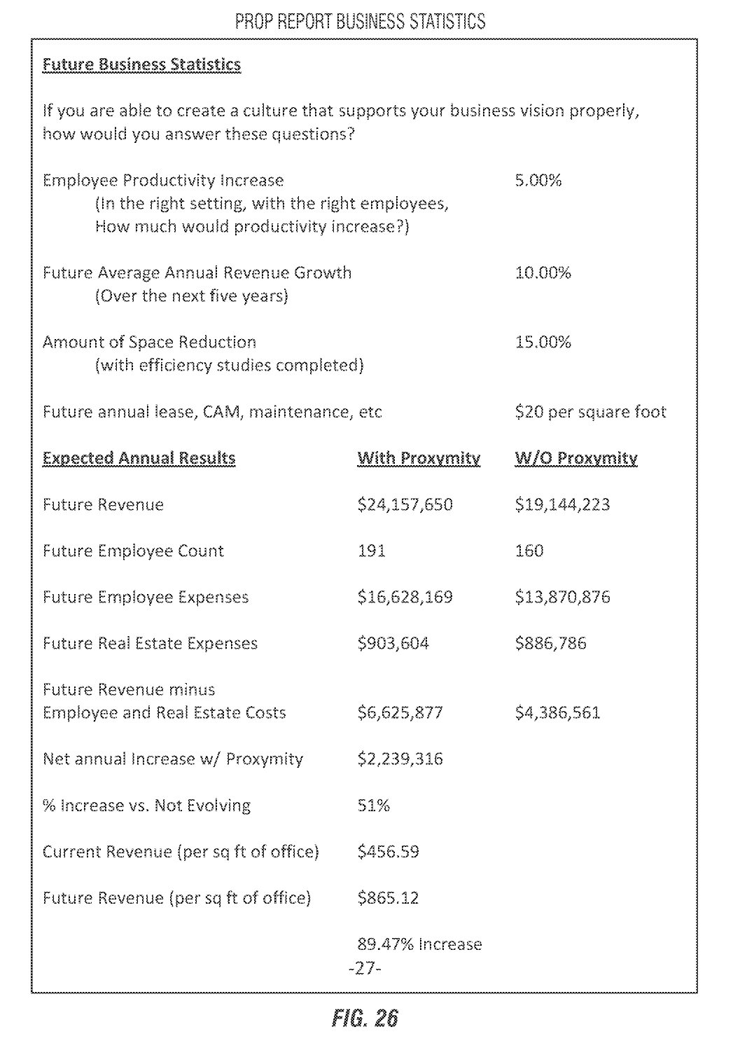

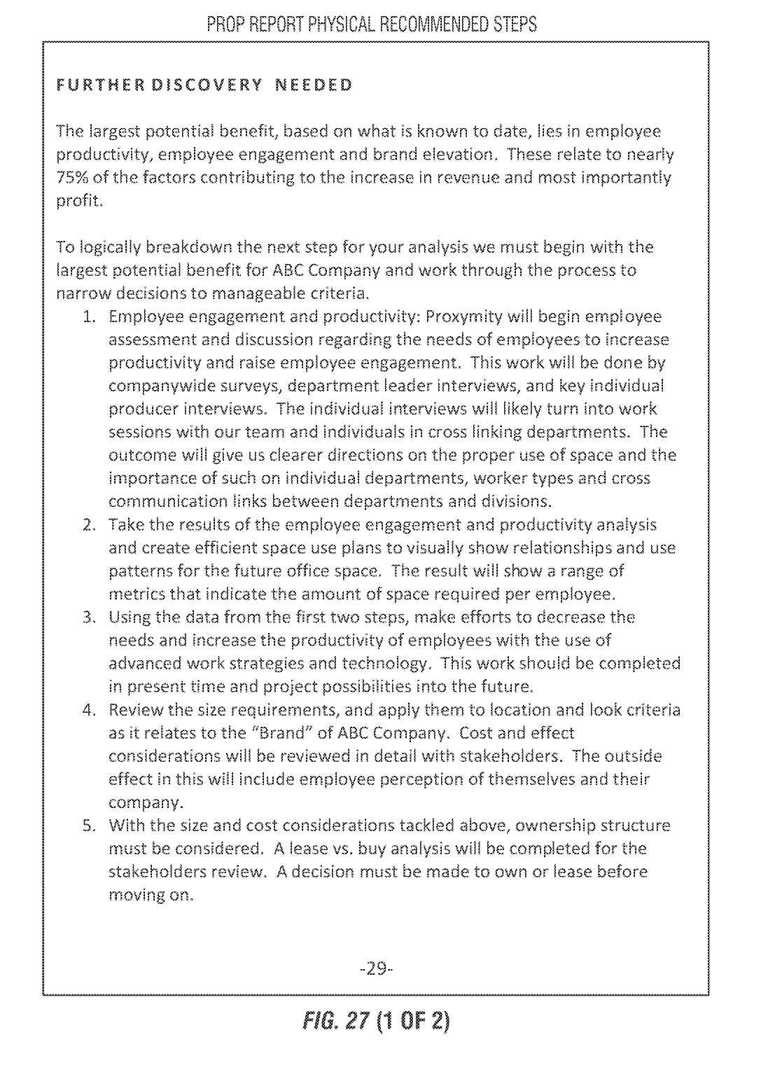

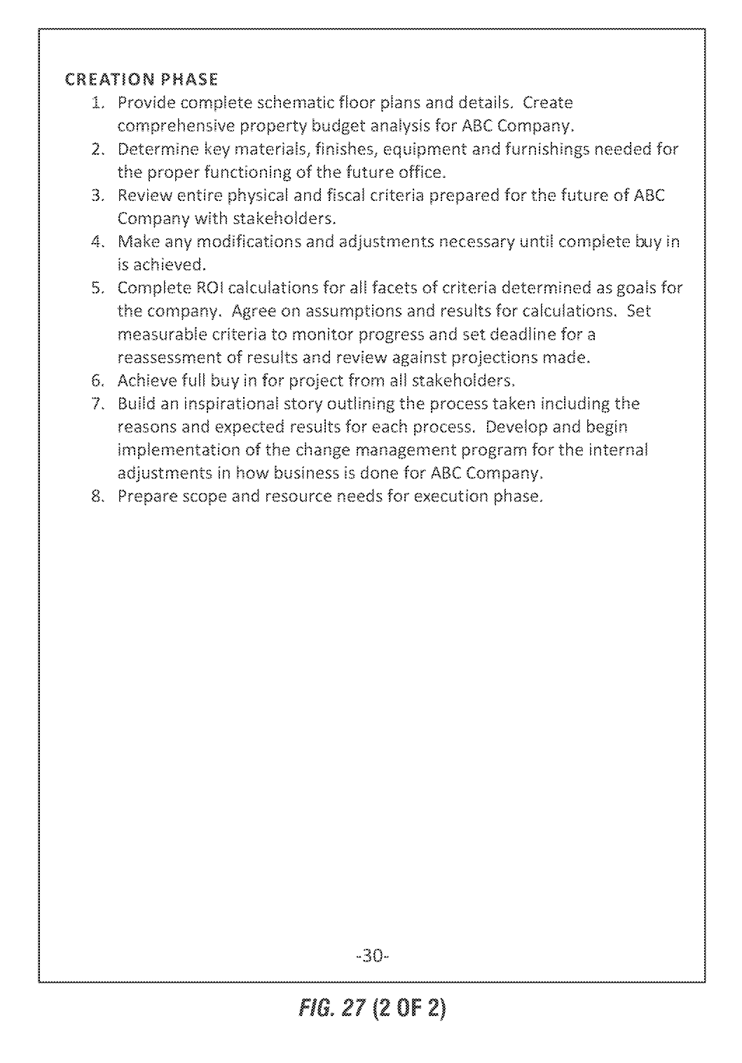

FIG. 26 provides an exemplary illustration of future business statistics for the business or organization based on the foregoing analysis recommending, for example, employee productivity increases, future average annual revenue growth increases, an amount of space reduction and/or future annual lease, CAM, maintenance changes that support the business or organization's vision. Also illustrated in FIG. 27 are the expected annual results using the process of the present invention that ensures that the metrics that support and address the business or organization's strategy for growth and profitability are highly correlated with the business's property. Several factors, such as future revenue, future employee, future employee count, future employee expenses, future real estate expenses, etc., are analyzed and illustrative comparing the benefits of the present invention being applied to a business's property strategy and not being applied to a business's property strategy.

FIG. 27, specifically pages 1 and 2 of 2, provide information regarding further discovery which may be needed to understand how the foregoing analysis or benefits provided by the present invention may further benefit the business or organization's strategies for growth and profitability by correlating these with the business's property, the features of the property and uses and function of their property. Several criteria are provided to address the strategy for those factors that contribute heavily to the business or organization's growth and profitability. These factors are considered in light of how they are impacted by the business's property, the features of the property and the uses and functions of the property. Page 2 of 2 in FIG. 27 provides an exemplary creation phase set of criteria that may be used for preparation for initiating execution phase for selecting a property, a set of potential uses and functions of the selected property and one or more features of the selected property.

The system and method carried out in the above examples can be performed on a computer system. Software can be used to allow data entry through a user interface such as a keyboard, touch screen, or other device.

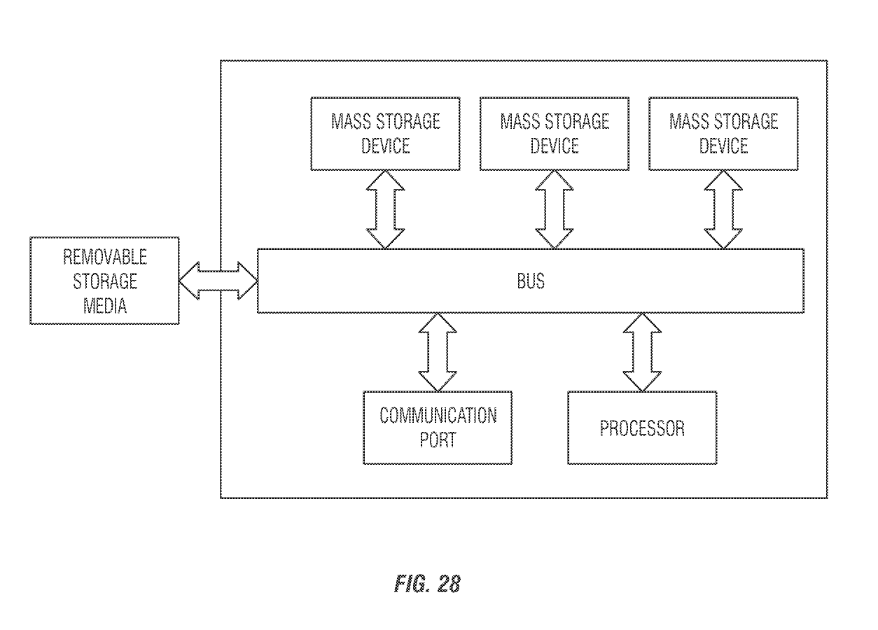

FIG. 28 illustrates a graphical user interface (GUI) 100 that could be used. The criteria/metrics from one or more of the workbooks could loaded, or download or otherwise obtained and populated within an application or software configured to provide one or more PROP report outputs. A manual or preferably an electronic/computer-based spreadsheet could be used to calculate criteria/metrics for the PROP report (per FIGS. 18-27) and enter it in GUI of FIG. 28. As can be seen in FIG. 28, other factors can be input and used for calculating or performing terms of the invention. But this shows how, for each analysis (which likely will differ somewhat from each other), a template like FIG. 28 can be used to guide data entry such that the program can automatically calculate criteria/metrics for a PROP report. By any number of presently available means, reports can be sent to the business/organization (automatically printing physical copies, email copies, fax copies, etc.).

Similarly, the present invention could be implemented by a computerized system configured to make transactions and/or purchases based upon, for example, the criteria/metrics of the PROP report. Alternatively a broker or other intermediary could be used.

As can be appreciated, the computer system can be configured according to need or desire.

Embodiments of the present invention include various steps that may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 28 is an example of a computer system 1700 with which embodiments of the present invention may be utilized. According to the present example, the computer system includes a bus, at least one processor, at least one communication port, a main memory, a removable storage media, a read only memory, and a mass storage.

Processor(s) can be any known processor, such as, but not limited to, an Intel® Itanium® or Itanium 2® processor(s), or AMD® Opteron® or Athlon MP® processor(s), or Motorola® lines of processors. Communication port(s) can be any of an RS-232 port for use with a modem based dialup connection, a 10/100 Ethernet port, or a Gigabit port using copper or fiber. Communication port(s) may be chosen depending on a network such a Local Area Network (LAN), Wide Area Network (WAN), or any network to which the computer system connects.

Main memory can be Random Access Memory (RAM), or any other dynamic storage device(s) commonly known in the art. Read only memory can be any static storage device(s) such as Programmable Read Only Memory (PROM) chips for storing static information such as instructions for processor.

Mass storage can be used to store information and instructions. For example, hard disks such as the Adaptec® family of SCSI drives, an optical disc, an array of disks such as RAID, such as the Adaptec family of RAID drives, or any other mass storage devices may be used.

Bus communicatively couples processor(s) with the other memory, storage and communication blocks. Bus can be a PCI/PCI-X or SCSI based system bus depending on the storage devices used.

Removable storage media can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

Embodiments of the present invention have been set forth in the drawings and in the specification and all those specific terms are employed, these are used in the generically descriptive sense only and are not used for the purpose of limitation. Changes in the form as well as substitution of equivalents are contemplated as circumstances may suggest or are rendered expedient without departing from the spirit or scope of the invention as further defined in the following claims.

What is claimed is:

1. A method for correlating a business's current and future strategies for growth and profitability with its commitment to and use of physical property, comprising:
performing a study of a business and its current and future strategies for growth and profitability;
conducting a study of a physical piece of property, the study including an analysis of functional and potential uses of the physical property and one or more features of the physical property;
identifying a set of factors related to the use and function of the physical piece of property and its one or more features that drive the business's current and future strategies for growth and profitability;
determining if an expense related to the physical property its use and function and the one or more features of the physical property supports one or more of the set of factors that drive the business's current and future strategies for growth and profitability;
recommending a property its use and function and the one or more features of the physical property that collectively have a high correlation with the one or more set of factors driving the business's current and future strategies for growth and profitability;
converting the expense of the physical property its use and function and the one or more features of the physical property into an investment providing a return to the business based on the high correlation between:
a. the set of factors related to use and function of the physical piece of property or its one or more features that drive the business's current and future strategies for growth and profitability; and
b. the physical property and the one or more features of the physical property;
wherein said recommendation is independent of any interest of the recommending party in the physical property.

2. The method of claim 1 wherein the set of factors related to use and function of the physical piece of property or its one or more features that drive a business's current and future strategies for growth and profitability include at least one of:
a. an employee of the business;
b. a client of the business;
c. a product/service of the business;
d. a technology of the business;
e. leadership of the business;
f. financial investments of the business;
g. methods practiced by the business.

3. The method of claim 1 wherein the set of factors related to a use of the physical property or its one or more features that drive a business's current and future strategies for growth and profitability include consideration of at least one of:
a. an economy related to the business;
b. an industry related to the business;
c. a community associated with the business;
d. a society associated with the business.

4. The method of claim 1 wherein the study of the physical property includes an analysis of at least one or more physical aspects of the property, comprising:
a. functionality of the property;
b. size of the property;
c. an adaptability factor of the property;
d. location of the property;
e. look of the property.

5. The method of claim 1 wherein the study of the physical property includes an analysis of at least one or more financial aspects of the property, comprising:
a. duration of use of the property;
b. cost of the property;
c. value of the property;
d. revenue from the property;
e. timing of the property.

6. The method of claim 1 wherein the high correlation increases the business's return on the investment in the physical property and the one or more features of the physical property by:
a. increasing productivity of the business;
b. increasing attractiveness of the business;
c. increasing creativity of the business;
d. decreasing waste of the business.

7. The method of claim 1 wherein the high correlation in the physical property and the one or more features of the physical property maximizes the business's rate of investment, return on investment and/or cash flow.

8. The method of claim 1 wherein said recommendation includes a set of property and property feature solutions that are aligned with the business's current and future strategies for growth and profitability.

9. A method for correlating a business's current and future strategies for growth and profitability with its acquisition and use of physical property, comprising:
performing a study of a business to identify a set of factors driving the business's strategy for growth and profitability;
conducting a study of one or more properties comprising an analysis of a set of potential uses and functions of:
a. the property; and
b. one or more features of the property;
selecting based upon the use and function analysis:
a. a property from the one or more properties wherein the set of potential uses and functions of the selected property have a high correlation factor with the set of factors driving the business's strategy for growth and profitability; and
b. a set of features selected from the one or more features of the property wherein the set of potential uses and functions of the one or more features of the selected property have a high correlation factor with the set of factors driving the business's strategy for growth and profitability;
converting the expense of acquiring the selected property and the one or more features of the selected property into an investment providing a return to the business based on said high correlation factor between:
a. the set of potential uses and functions of the selected property and the set of factors driving the business's strategy for growth and profitability; and
b. the set of potential uses and functions of the one or more features of the selected property and the set of factors driving the business's strategy for growth and profitability;
recommending the selected property and the set of potential uses and functions of the selected property and the one or more features of the selected property independent of any interest of the recommending party in the selected property or features.

10. The method of claim 9 comprising balancing the acquisition expense of the selected property and features with the:
a. set of factors driving the business's strategy for growth and profitability;
b. the correlation factor.

11. The method of claim 9 comprising assembling a team with a set of interests independent of the one or more properties and features of the properties to conduct the study.

12. The method of claim 9 wherein the study comprises an analysis of use and function of the one or more properties and features of the properties over a duration of an ownership interest held by the business.

13. The method of claim 9 wherein the set of potential uses and functions of the property and the one or more features of the property include analysis of at least one of:
a. a type of employee of the business;
b. a type of client of the business;
c. a type of product/service of the business;
d. a type of technology of the business;
e. a type of leadership of the business;
f. financial investments of the business;
g. methods practiced by the business.

14. The method of claim 9 wherein the set of potential uses and functions of the property and the one or more features of the property include analysis of at least one of:
a. an economy related to the business;
b. an industry related to the business;
c. a community associated with the business;
d. a society associated with the business.

15. The method of claim 9 wherein the analysis of the set of potential uses and functions of the property and the one or more features of the property includes at least one or more physical aspects of the property, comprising:
a. functionality of the property;
b. size of the property;
c. an adaptability factor of the property;
d. location of the property;
e. look of the property.

16. The method of claim 9 wherein the analysis of the set of potential uses and functions of the property and the one or more features of the property includes at least one or more financial aspects of the property, comprising:
a. duration of use of the property;
b. cost of the property;
c. value of the property;
d. revenue from the property;
e. timing of the property.

17. The method of claim 9 wherein the high correlation factor increases the business's return on the investment in a selected property and features of the selected property by:
a. increasing productivity of the business;
b. increasing attractiveness of the business;
c. increasing creativity of the business;
d. decreasing waste of the business.

18. The method of claim 9 wherein the high correlation factor for the selected property and features of the selected property maximizes the business's rate of investment, return on investment and/or cash flow.

19. A method for correlating a business's current and future strategies for growth and profitability with its acquisition and use of physical property, comprising:
providing a software system executed on a computer;
engaging a business looking for a solution for driving at least one part of the business's strategy for growth and profitability through the business's commitment to and use of a business property;
performing a study of the business to identify a set of factors driving the business's strategy for growth and profitability;
conducting a study of one or more properties comprising an analysis executed by the software system on the computer of a set of potential uses and functions of:
a. each property; and
b. one or more features of each property;
selecting based upon the use and function analysis:
a. a property from the one or more properties wherein the set of potential uses and functions of the selected property have a high correlation factor with the set of factors driving the business's strategy for growth and profitability; and
b. a set of features selected from the one or more features of the property wherein the set of potential uses and functions of the one or more features of the selected property have a high correlation factor with the set of factors driving the business's strategy for growth and profitability;
executing software on the computer to determine the correlation factor;
converting the expense of acquiring the selected property and the one or more features and functions of the selected property into an investment providing a return to the business based on said high correlation factor between:
a. the set of potential uses and functions of the selected property and the set of factors driving the business's strategy for growth and profitability; and
b. the set of potential uses and functions of the one or more features of the selected property and the set of factors driving the business's strategy for growth and profitability;
issuing a set of reports to the business executed by the software on the computer identifying the correlation factor for each of the one or more properties and the one or more features of the properties; and
recommending the selected property and the set of potential uses and functions of the selected property and the one or more features of the selected property independent of any interest of the recommending party in the selected property or features.

20. The method of claim 19 wherein the study comprises an analysis executed by software on the computer of use and function of the one or more properties and features of the properties over a duration of an ownership interest held by the business.
